(19) United States
(12) Patent Application Publication
(10) Pub. No.: US 2015/0076949 A1
(43) Pub. Date: Mar. 19, 2015

(54) First open thermodynamic system for electric vehicles : that use the kinetic energy of any vehicle for electric production

(71) Applicant: Abuanthony Abdul Alim, Daytona, FL (US)

(72) Inventor: Abuanthony Abdul Alim, Daytona, FL (US)

(21) Appl. No.: 14/028,302

(22) Filed: Sep. 16, 2013

(51) Int. Cl. H02K 47/00

(52) U.S. Cl. CPC H02K 47/00; Y10S 74/09; H02K 53/00
USPC 310/113; 74/DIG. 9

(57) ABSTRACT

The OPEN thermodynamic system for vehicles must have these main ingredients, Every drive shaft, Axle or wheels that are a moving major part of the vehicle must have the components of the 3 phase generator system to create a rotating magnetic field with a stator to harness the clean electric power by converting the natural mechanical kinetic energy that all vehicles create when they move. Every drive shaft, Axle or wheel is a generator because they have all of the 3 phase generator components to make electricity from mechanical kinetic energy.

These generator systems can be sized to fit any vehicle and they can create from 0 to 300 KW of clean electricity or more. This present invention will advance vehicles by using 100% of the mechanical kinetic energy to convert it into clean 3 phase electricity. The Closed system for vehicles uses the components that cannot harness or convert anything.

### BACKGROUND OF THE INVENTION

The present invention relates to energy generator system and method more particularly, to a OPEN THERMODYNAMIC system for vehicles a method to re-use or recycle clean electricity from an Electrical motor.

Currently, steps have been made to develop electric vehicles, such as electric cars and the like. However, these vehicles often use the thermodynamic Closed system which use more power than it could generate during use. Moreover, these vehicles often have an internal combustion engine for power. With conventional vehicles that create a huge amount of Kinetic energy that can be harnessed and converted to electricity.

As can be seen, there is a need for an Open thermodynamic system to stop the search for fuels. Open System Model (basics)

In system theory, an open system is a system which continuously interacts with its environment or surroundings. The interaction can take the form of information, energy, or material transfers into or out of the system boundary, depending on the discipline which defines the concept. An open system is contrasted with the concept of an isolated system which exchanges neither energy, matter, nor information with its environment.

The concept of an open system was formalized within a framework that enabled one to interrelate the theory of the organism, thermodynamics, and evolutionary theory. This concept was expanded upon with the advent of information theory and subsequently systems theory. Today the concept has its applications in the natural and social sciences.

In the natural sciences an open system is one whose border is permeable to both energy and mass. In physics a closed system, by contrast, is permeable to energy but not to matter.

Open systems have a number of consequences. A closed system contains limited energies. The definition of an open system assumes that there are supplies of energy that cannot be depleted; in practice, this energy is supplied from some source in the surrounding environment, which can be treated as infinite for the purposes of study. One type of open system is the so-called radiant energy system, which receives its energy from solar radiation—an energy source that can be regarded as inexhaustible for all practical purposes.

Interactions of Thermodynamic Systems Type of System

| | Mass flow | Work | Heat |
|---|---|---|---|
| Open | $ | $ | $ |
| Closed | X | X | $ |
| Thermally isolated | X | $ | X |
| Mechanically isolated | X | X | X |
| Isolated | X | X | X |

History of the invention of the generator to be advanced.

Rotating magnetic fields Main articles: Rotating magnetic field and Alternator The rotating magnetic field is a key principle in the operation of alternating-current motors. A permanent magnet in such a field rotates so as to maintain its alignment with the external field. This effect was conceptualized by Nikola Tesla, and later utilized in his, and others', early AC (alternating-current) electric motors. A rotating magnetic field can be constructed using two orthogonal coils with 90 degrees phase difference in their AC currents. However, in practice such a system would be supplied through a three-wire arrangement with unequal currents. This inequality would cause serious problems in standardization of the conductor size and so, to overcome it, three-phase systems are used where the three currents are equal in magnitude and have 120 degrees phase difference. Three similar coils having mutual geometrical angles of 120 degrees create the rotating magnetic field in this case. The ability of the three-phase system to create a rotating field, utilized in electric motors, is one of the main reasons why three-phase systems dominate the world's electrical power supply systems. Because magnets degrade with time, synchronous motors use DC voltage fed rotor windings, which allows the excitation of the machine to be controlled and induction motors use short-circuited rotors (instead of a magnet) following the rotating magnetic field of a multicoiled stator. The short-circuited turns of the rotor develop eddy currents in the rotating field of the stator, and these currents in turn move the rotor by the Lorentz force. In 1882, Nikola Tesla identified the concept of the rotating magnetic field. In 1885, Galileo Ferraris independently researched the concept. In 1888, Tesla gained U.S. Pat. No. 381,968 for his work. Also in 1888, Ferraris published his research in a paper to the Royal Academy of Sciences in Turn.

So it is nothing new about using the rotating magnetic field and coil wires to create electricity. The rotating movement of the tires and drive shafts are used in the Open System for a car. Everything that moves must be converted to energy in an Open system.

The Closed system of a car use 4 tires and 5 drive axles that spin with a rate from the motor. The motor burns gas to produce that movement. Once the gas is gone you are out of gas and need more. The 4 tires and 5 drive axles are dead. They are doing nothing but spinning out the gas.

The Open system for a car use 4 mechanical electric harness generator tires and 5 mechanical electric harness generator drive shafts. Each unit or generator system creates from 0 to 300 KW of clean 3 phase electricity from the spinning or rotation of the 37 motor. All moving things that are a part of an Open system must create energy.

The Closed system has dead parts such as drive shaft, axles and wheels that only spin out energy and can't make it. The definition of an open system assumes that there are supplies of energy that cannot be depleted; Every electric vehicle can be adapted to the Open system and machines too.

### SUMMARY OF THE INVENTION

In one aspect of the present invention, an energy system for a vehicle comprises a 37 electric Motor adapted to drive the vehicle via at least one of a 27 mechanical electric drive shaft and a 29 Mechanical electric wheel axle; at least one gears sets receiving rotation input from at least one of the 27 mechanical electric drive shaft and the 29 mechanical electric wheel axles and at least one energy Storage device receiving power output from the power generator systems 27, 29, 31, 33 and 35.

In another aspect of the present invention, an energy system comprises an electric motor Adapted to drive the vehicle via at least one of a 27 mechanical electric drive shaft and a 29 mechanical Electric wheel axle; at least one gear sets receiving rotation input from at least one of the 27 Mechanical electric drive shaft and the 29 mechanical electric wheel axles;

At least one energy storage device receiving power output from the electrical generation systems 27, 29, 31, 33 and 35; and an inverter to convert power to power usable to power the electric motor, wherein The at least one energy storage device includes one or more batteries, the at least one energy storage Device includes an output to electric flywheel storage and or batteries and or output to utilities.

These and other features, aspects and advantages of the present invention will become better Understood with reference to the following drawings, description and claims

the present invention relates to an electric generating system and More particularly, to “The first OPEN thermodynamic system for Vehicles” and or “Hybrid mechanical electric harness generators” a system and method to re-use or recycle clean electricity from a 37 electrical motor.

currently, steps have been made to develop electric vehicles, such as electric cars and the like. However, these vehicles “the Closed thermodynamic systems” Often use more power than they could generate during use. Moreover, these vehicles often Have an internal combustion engine to supply rotational output to a drive shaft. With Conventional Closed thermodynamic system vehicles, the energy or electricity is used up in the process Of movement and has to be replaced with more fossil fuel to power the engine.

as can be seen, there is a need for a system and method for reusing or Recycling clean electricity from an 37 electrical motor in a vehicle without the use of Fossil fuels or the use of the closed thermodynamic systems. Furthermore, the OPEN thermodynamic System is a system that generates more electricity than it use without the use of fossil fuels.

in one aspect of the present invention, an energy generation system for a Vehicle Comprises of a 37 electric motor adapted to drive the vehicle via at least One of a 27 mechanical electric Drive shaft and a 29 mechanical electric wheel axle or At least one gears sets receiving rotation input From at least one of the 27 Mechanical electric drive shaft. And at least one energy storage device receiving Power output from electrical devices “generators” 27, 29, 31, 33 and 35.

in another aspect of the present invention, an energy generation system Comprises an 37 electric motor adapted to drive the vehicle via at least one of a 27 Mechanical electric drive shaft and A 29 mechanical electric wheel axle; at least one Gears sets receiving rotation input from at least one Of the 27 mechanical electric Drive shaft and or the 29 mechanical electric wheel axles; at least one energy storage device receiving Power output from the generation of power from the 27 mechanical electric drive shaft and or 29 mechanical electric wheel axle and or 31 mechanical electric wheels; and an inverter to convert Power generated by 27 mechanical electric drive shaft and or 29 mechanical electric wheel axle and or The 31 mechanical electric wheels and or 33 vehicle attachment and or a 35 mechanical Electric vehicle trailer for power usable to power the 37 electric motor, wherein the At least one energy storage device includes one or more batteries, or at least one Energy storage device includes electric flywheel storage, and or at least two Generators are connected to receive rotation output from the same gears sets.

### BRIEF DESCRIPTION OF THE DRAWINGS

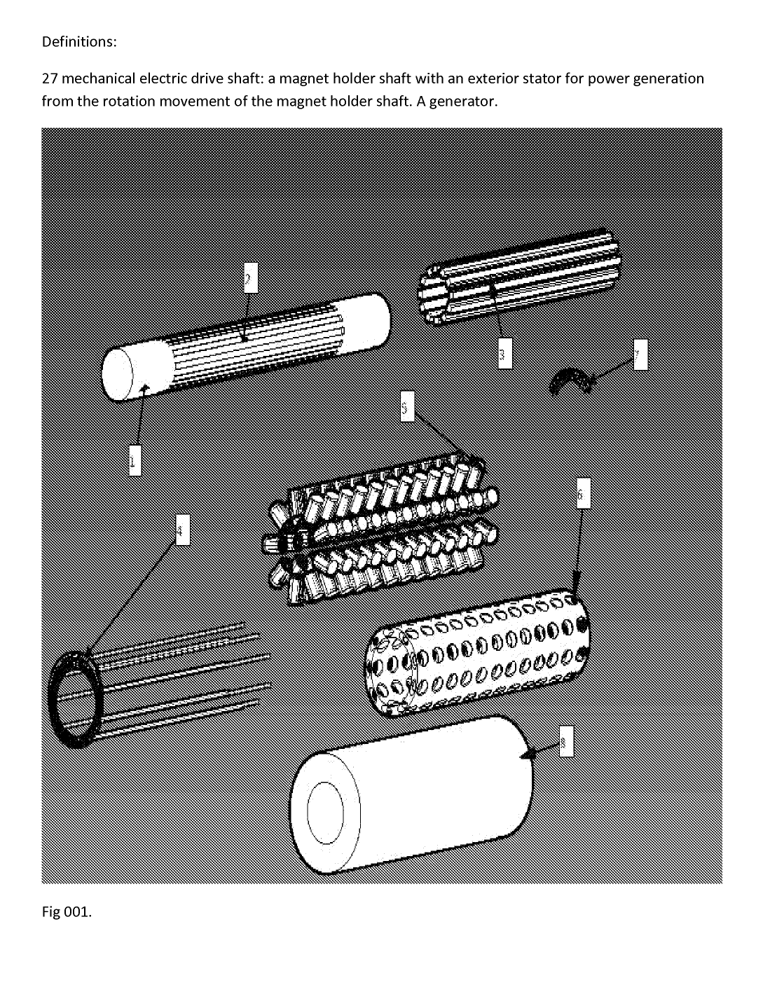

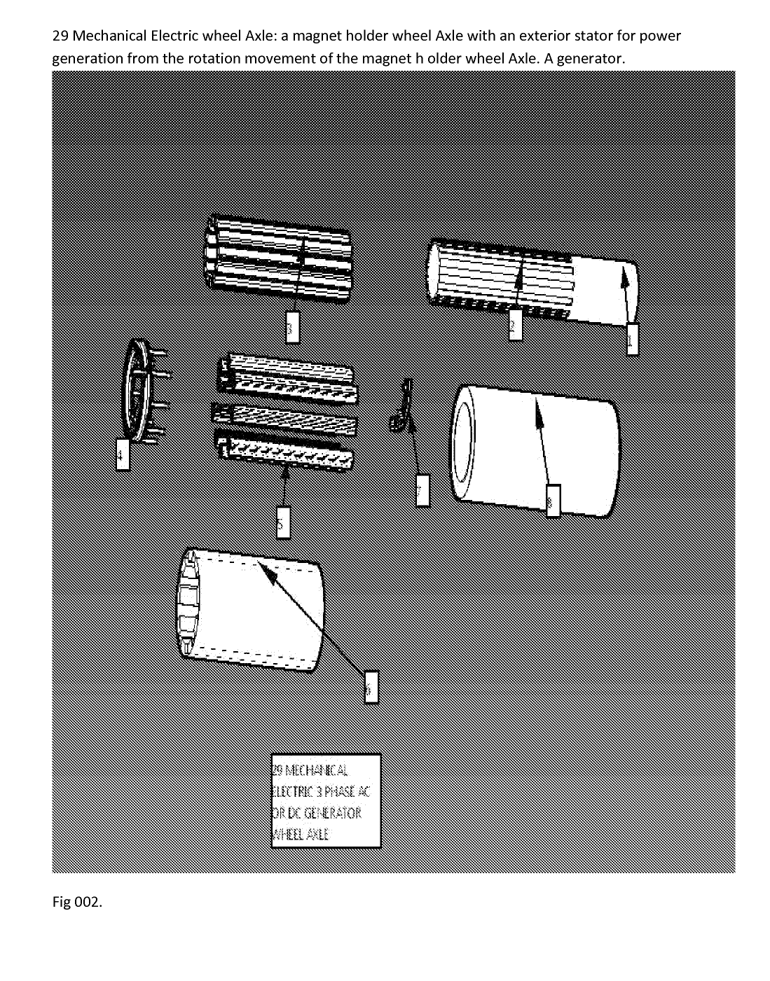

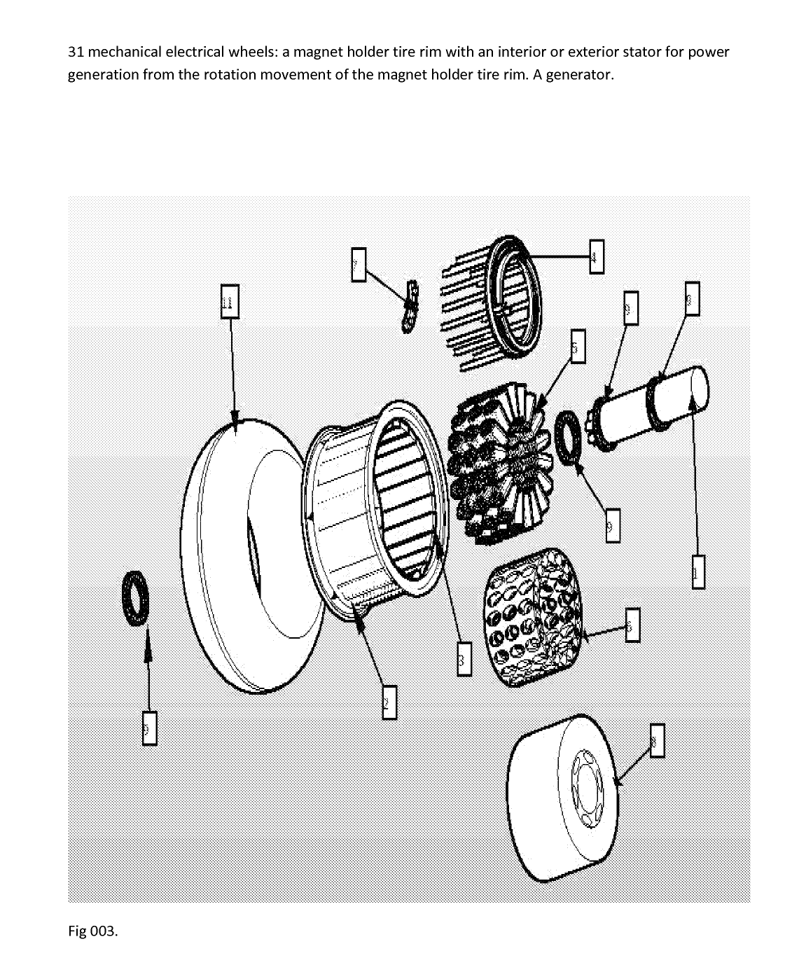

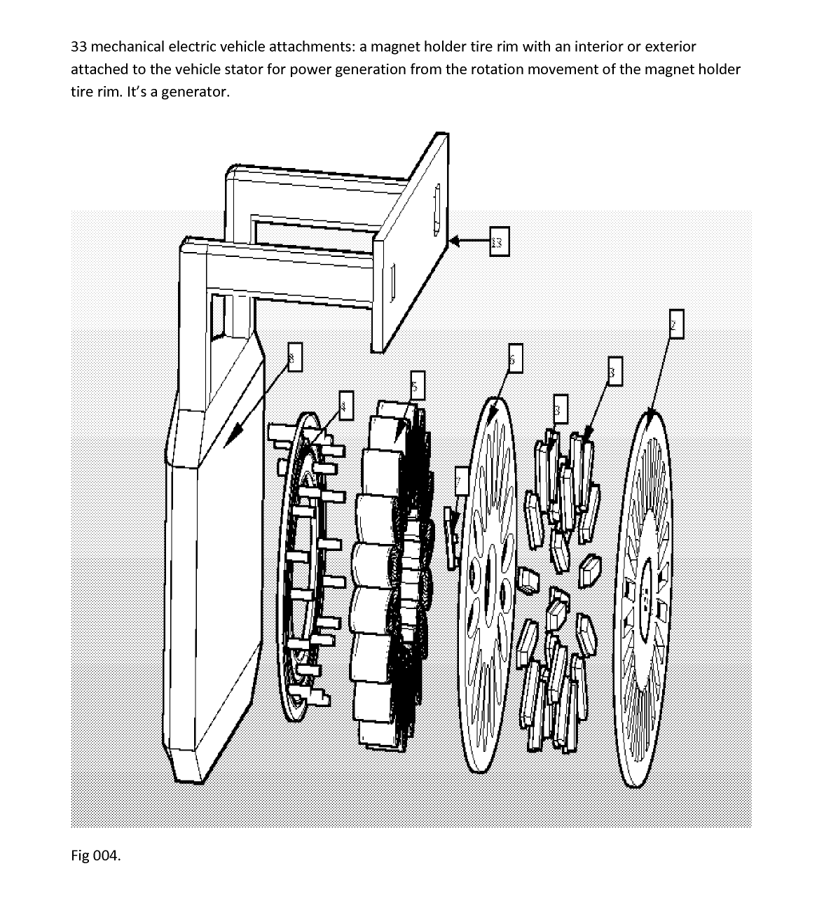

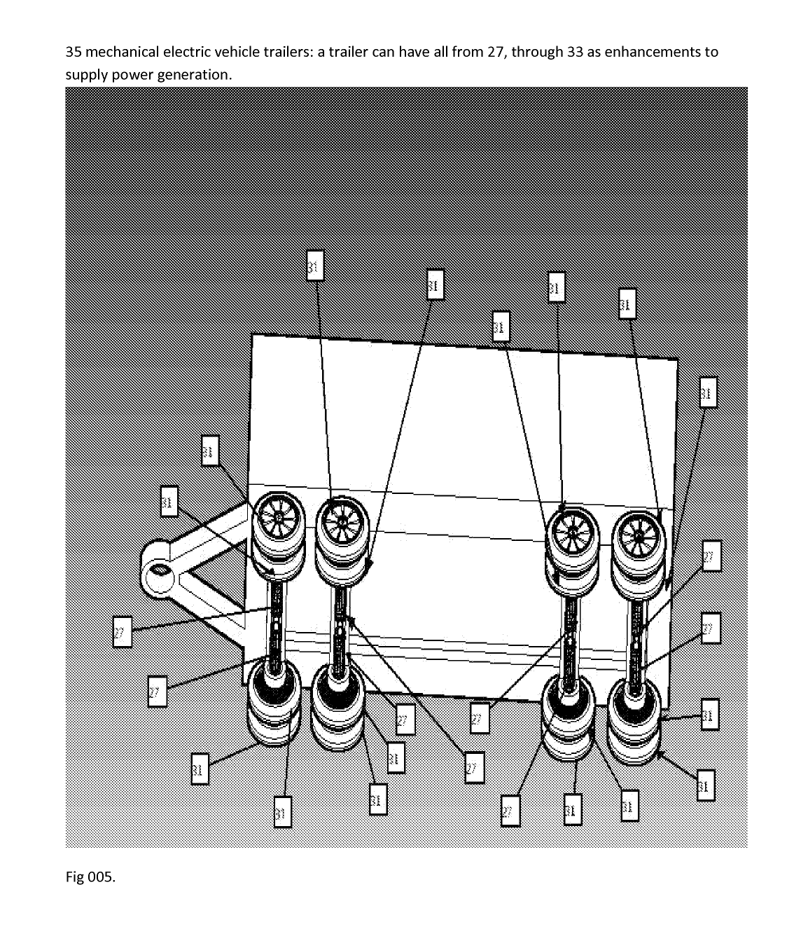

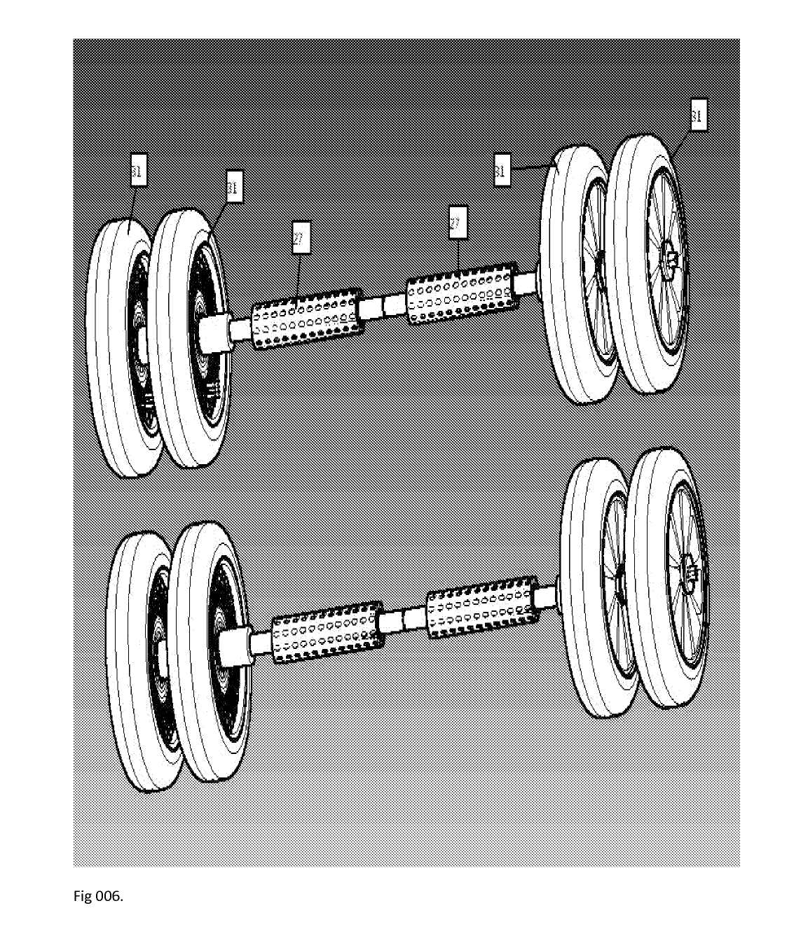

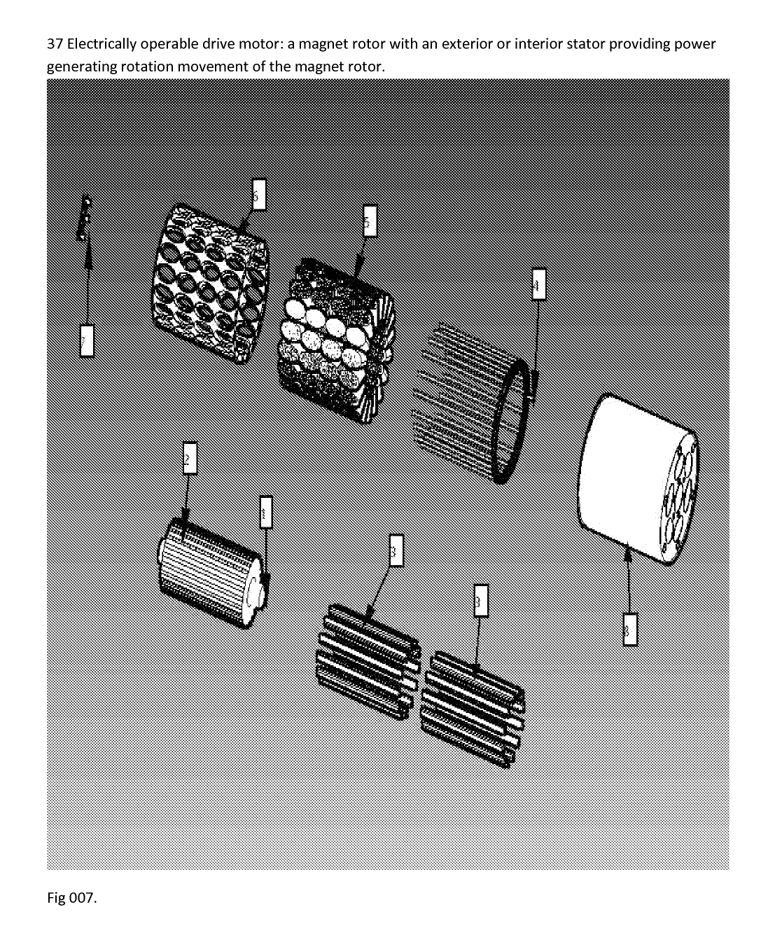

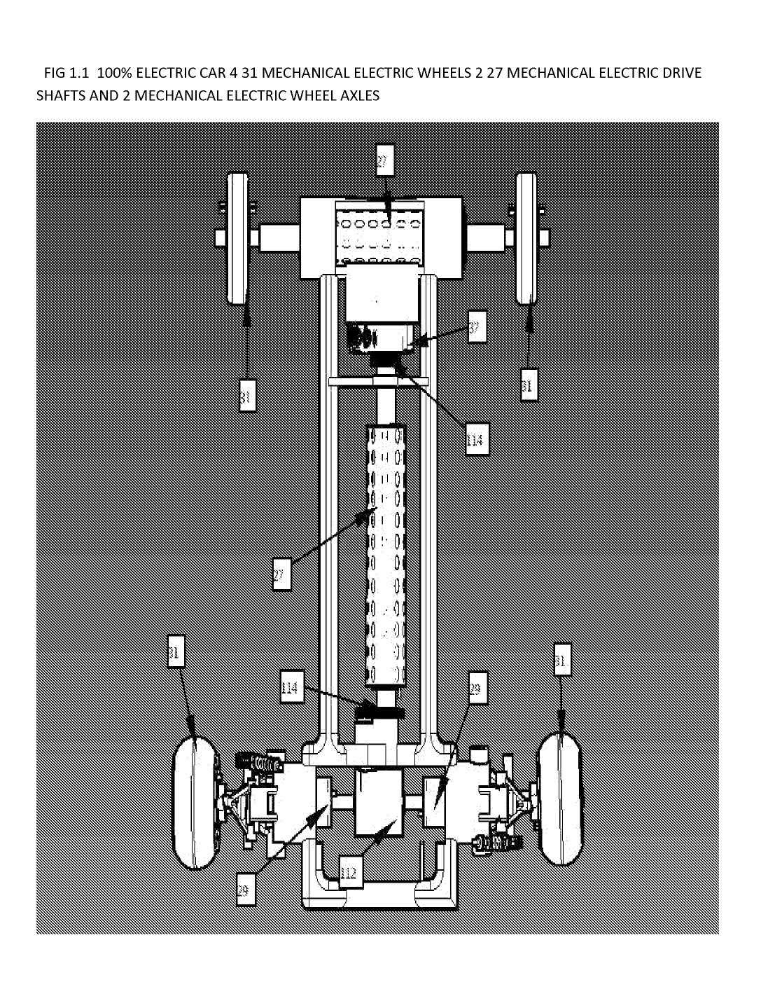

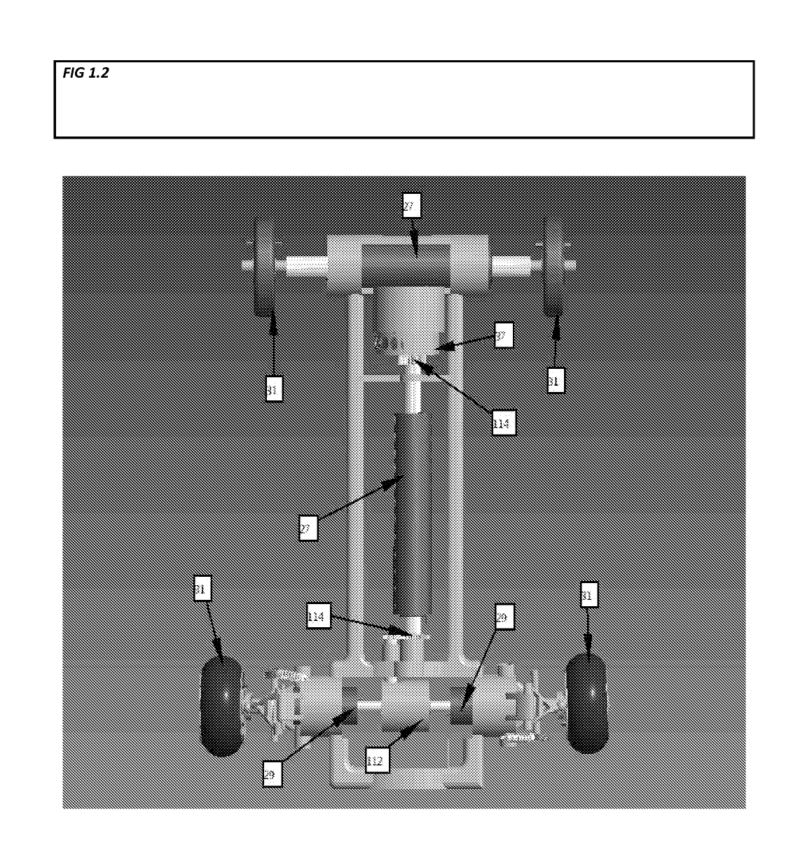

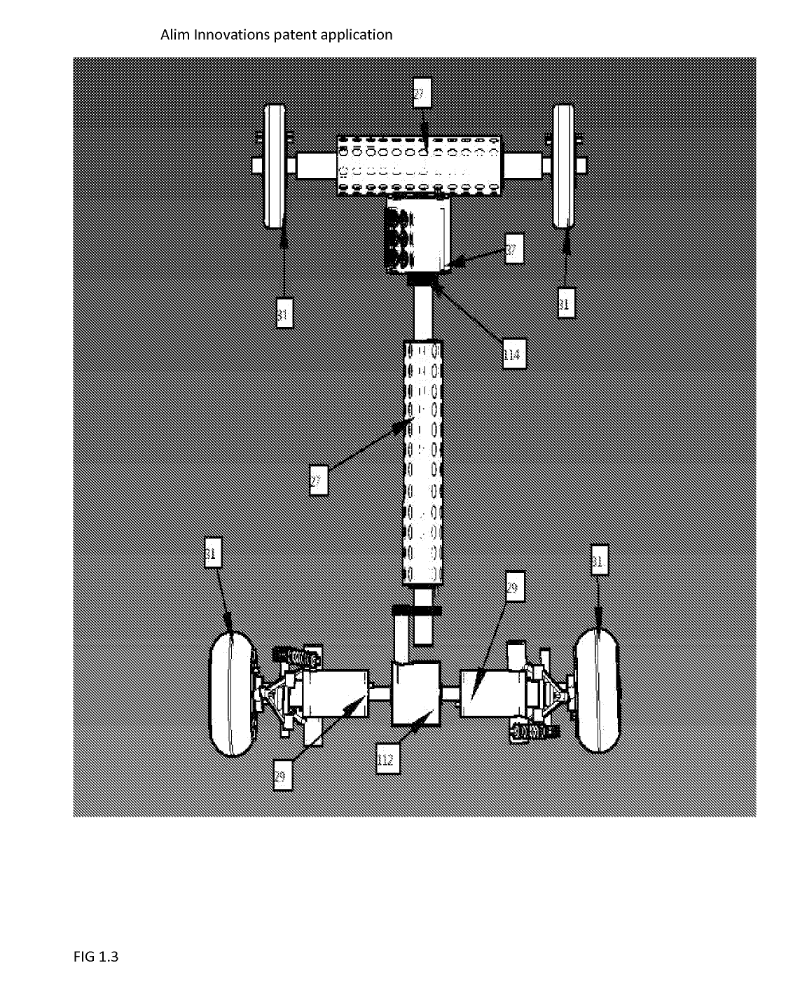

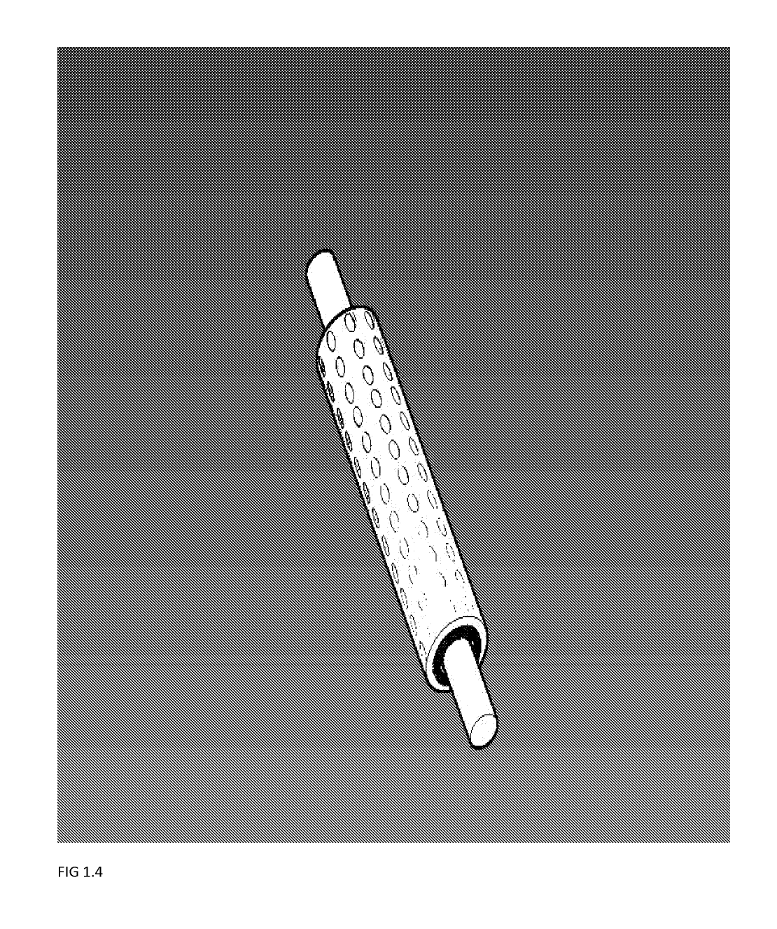

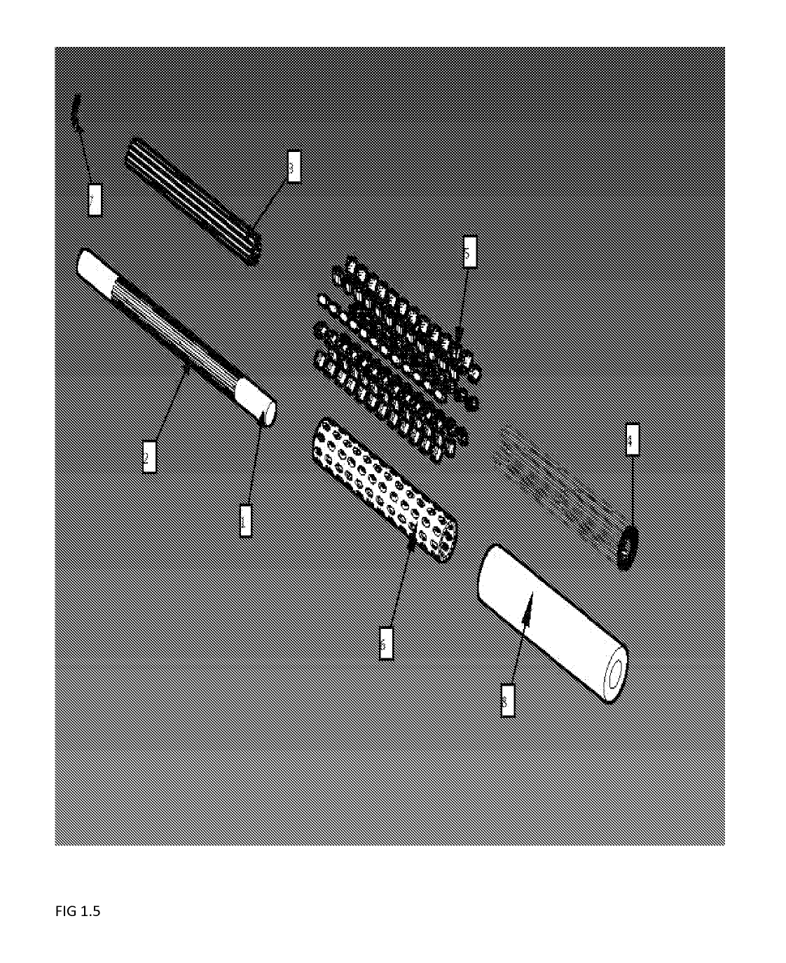

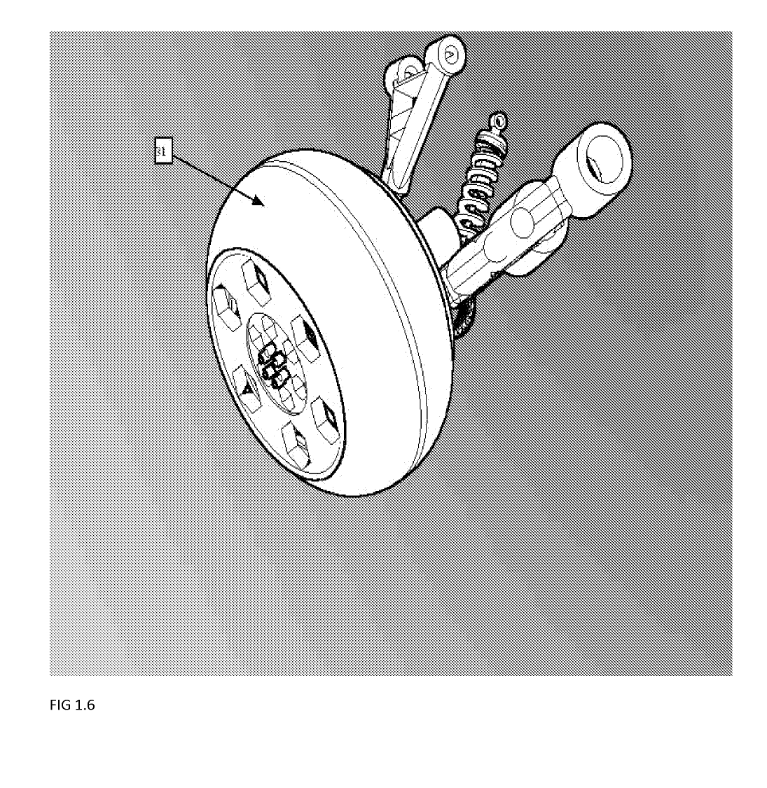

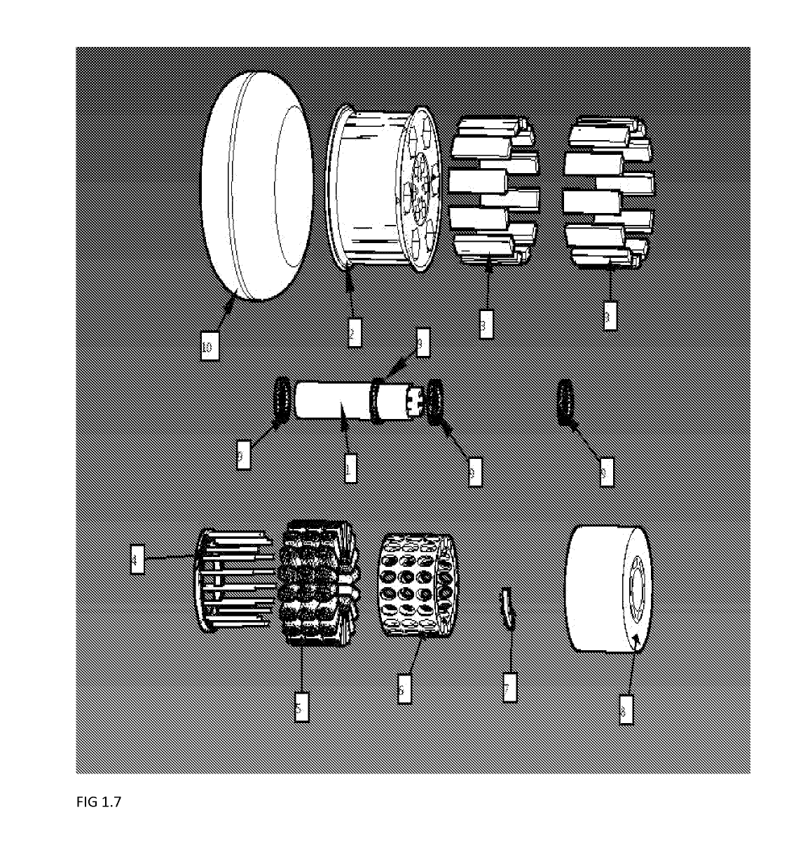

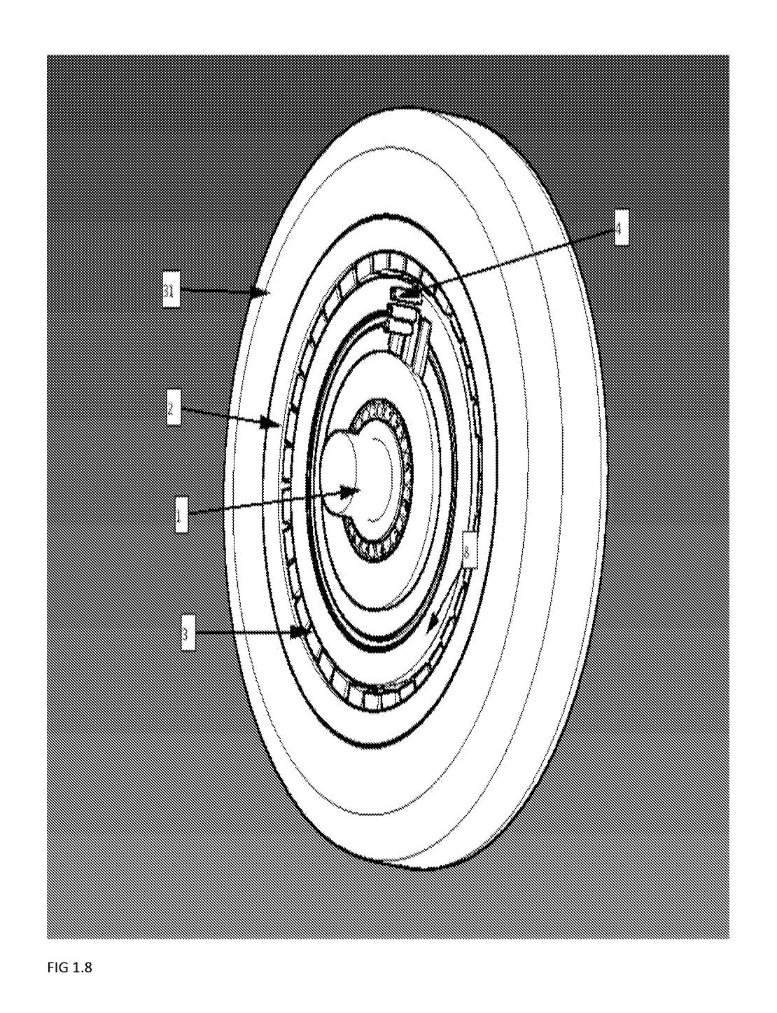

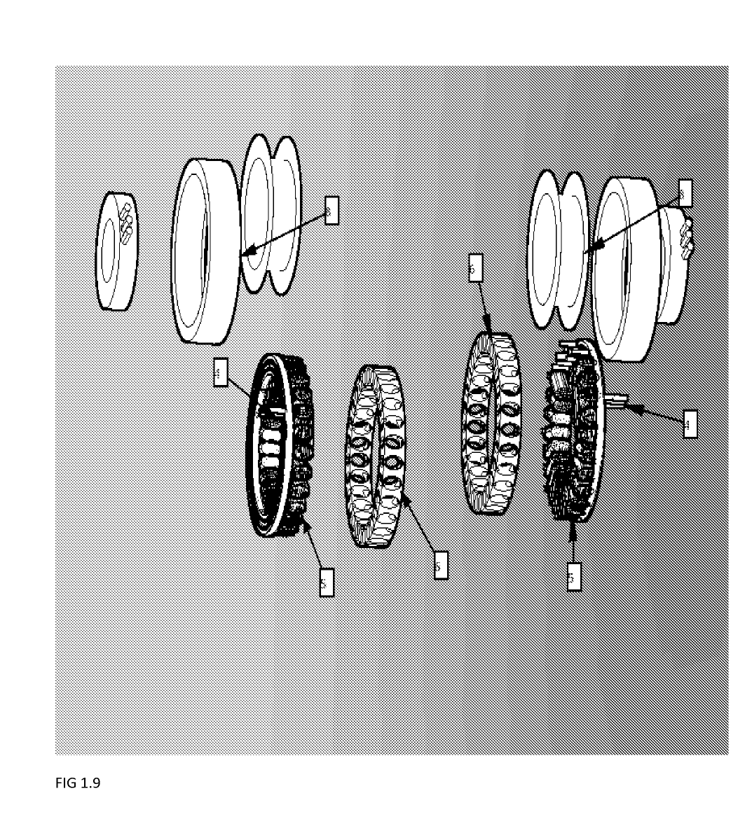

Page 41. FIG. 001. Is of the components of a driveshaft that is configured into a 3 phase generator system.

This is an open view of components 1. Through 8. Each is defined on page 97

27 mechanical electric drive shaft: a magnet holder shaft with an exterior stator for power generation from the rotation movement of the magnet holder shaft. It is a generator.

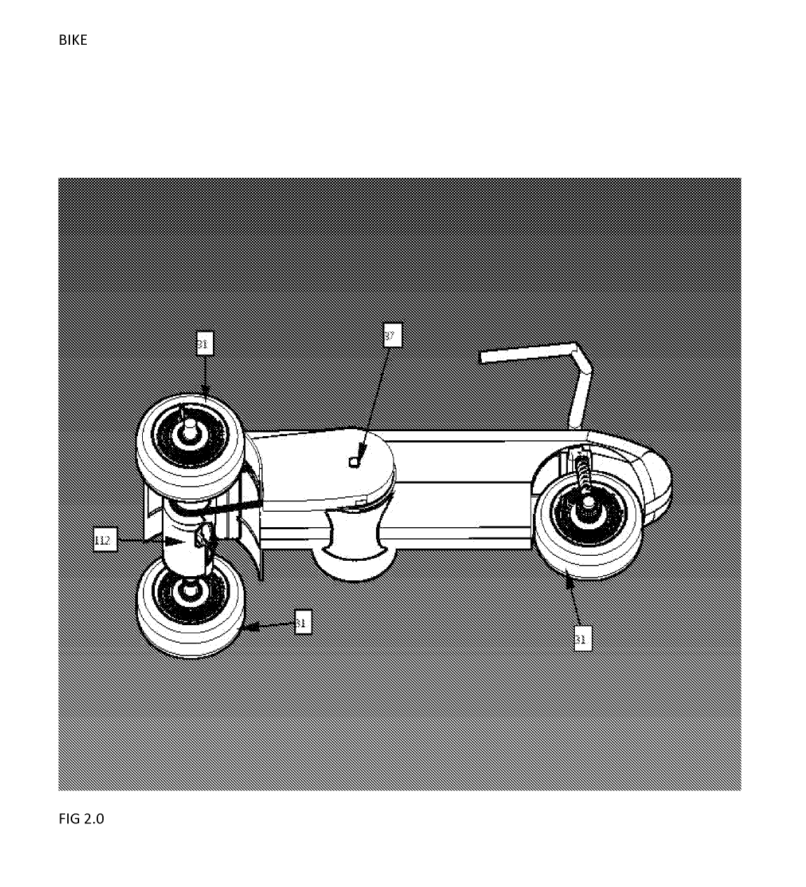

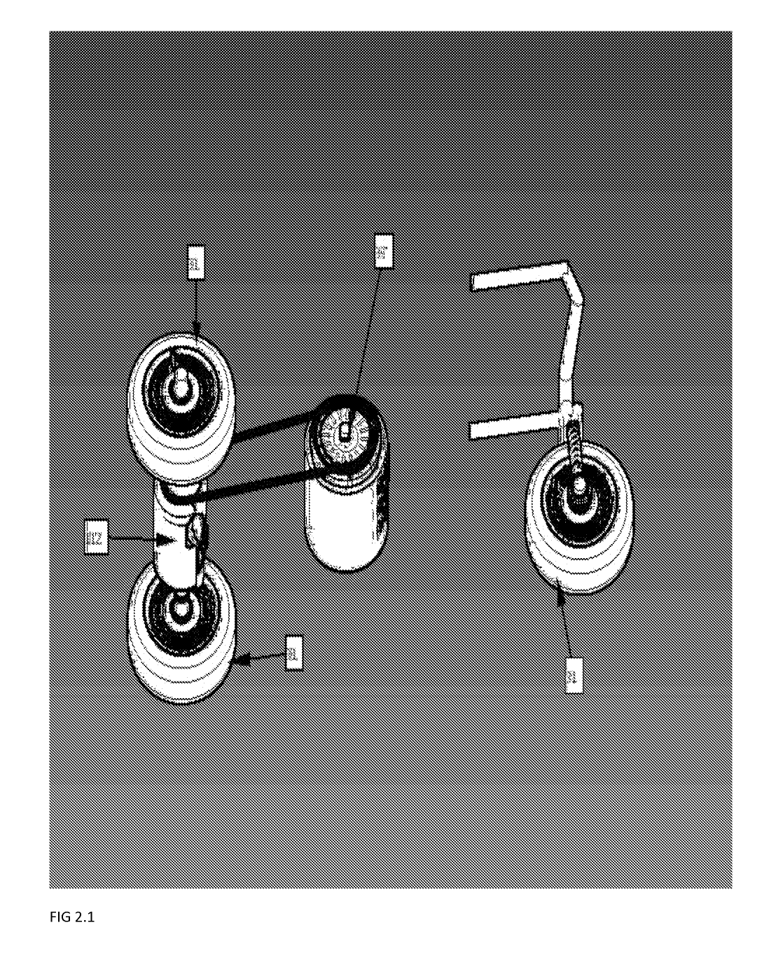

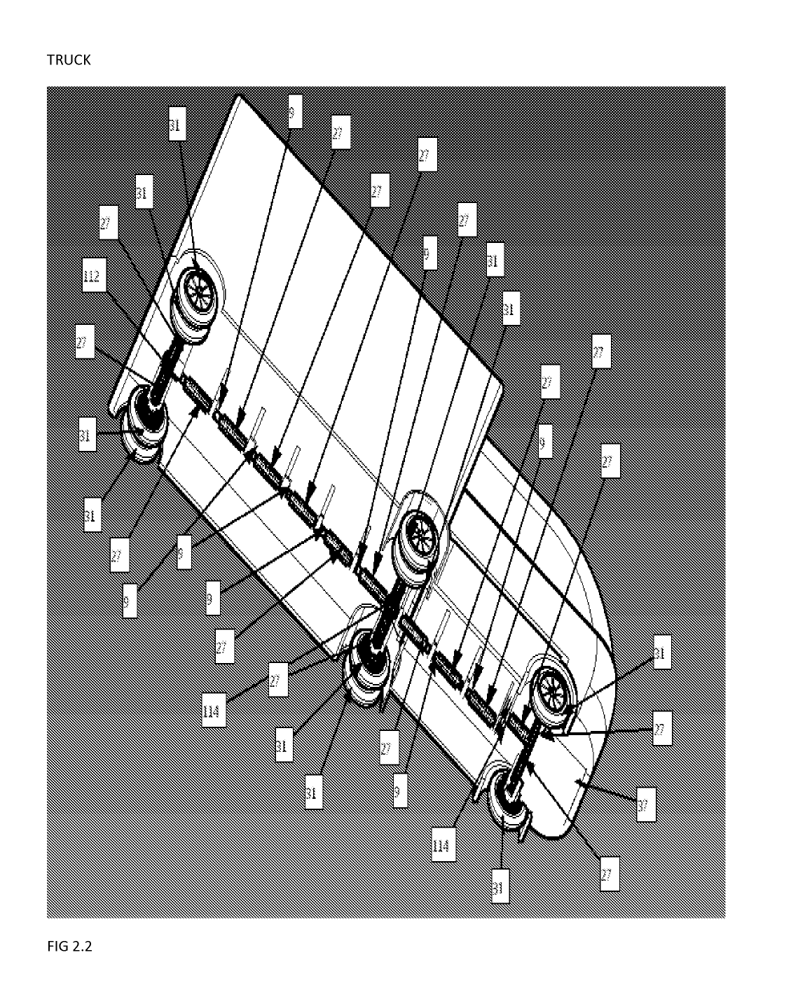

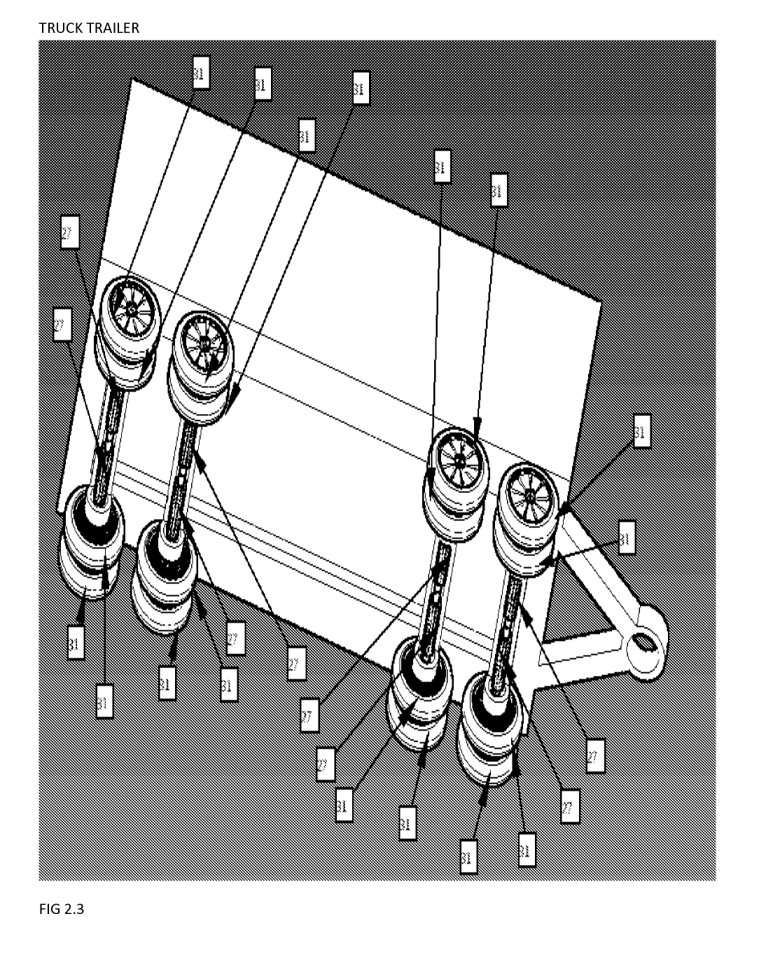

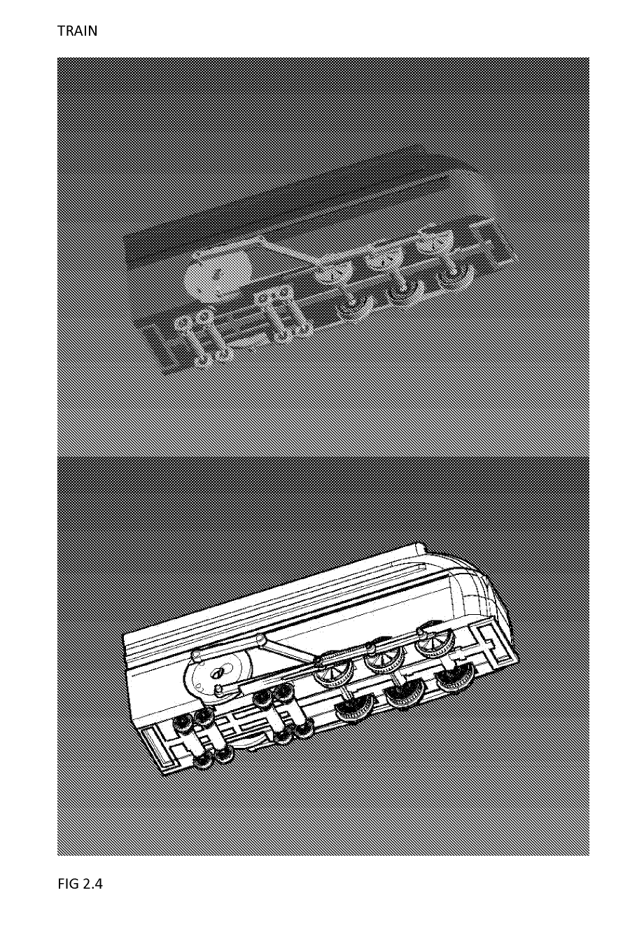

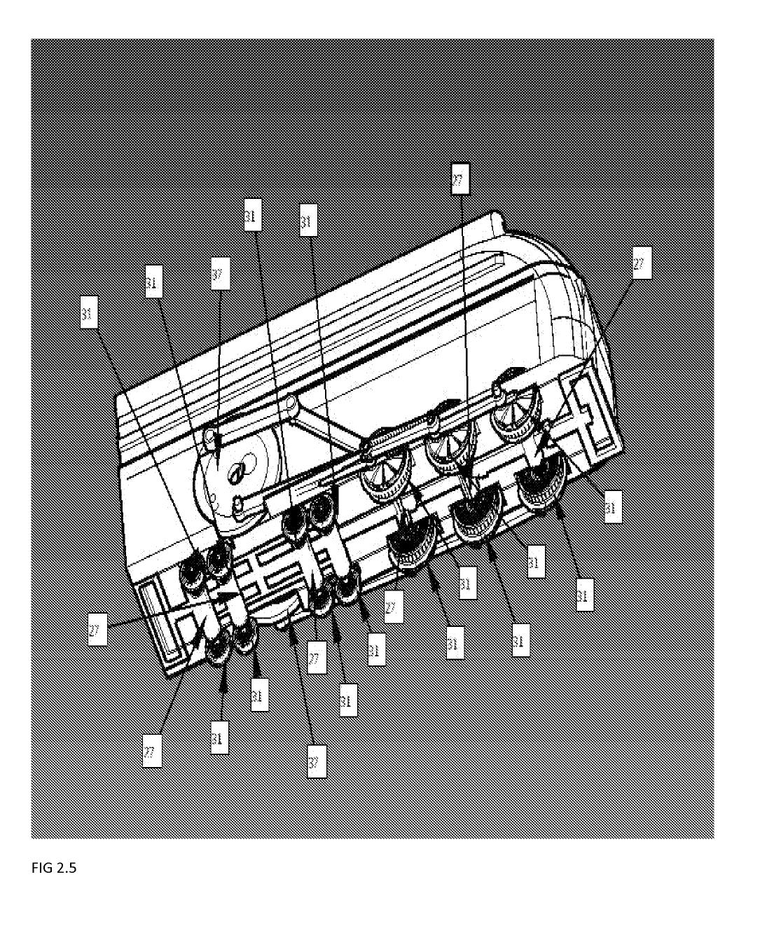

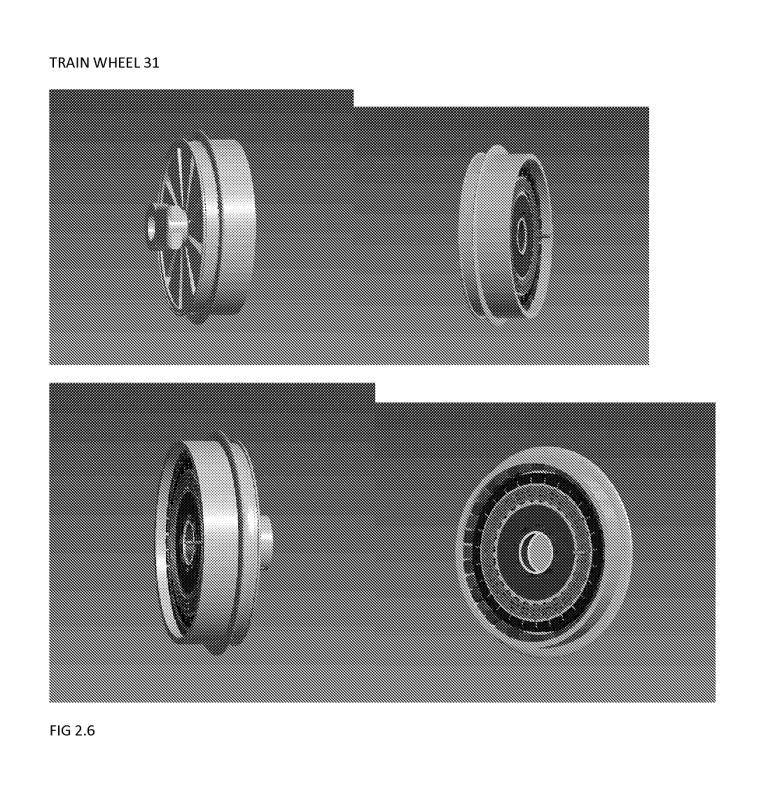

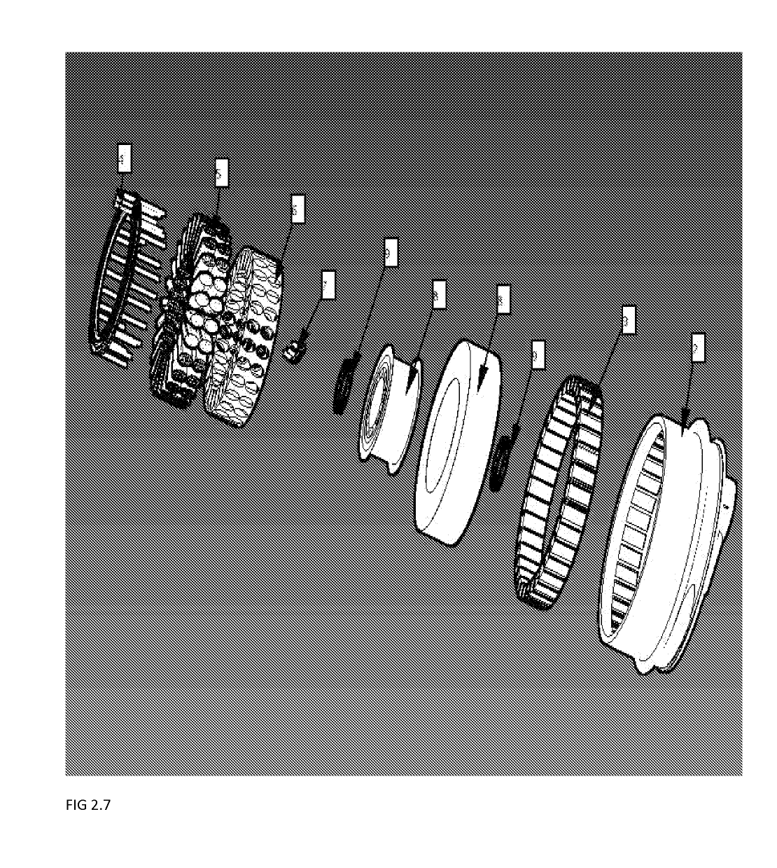

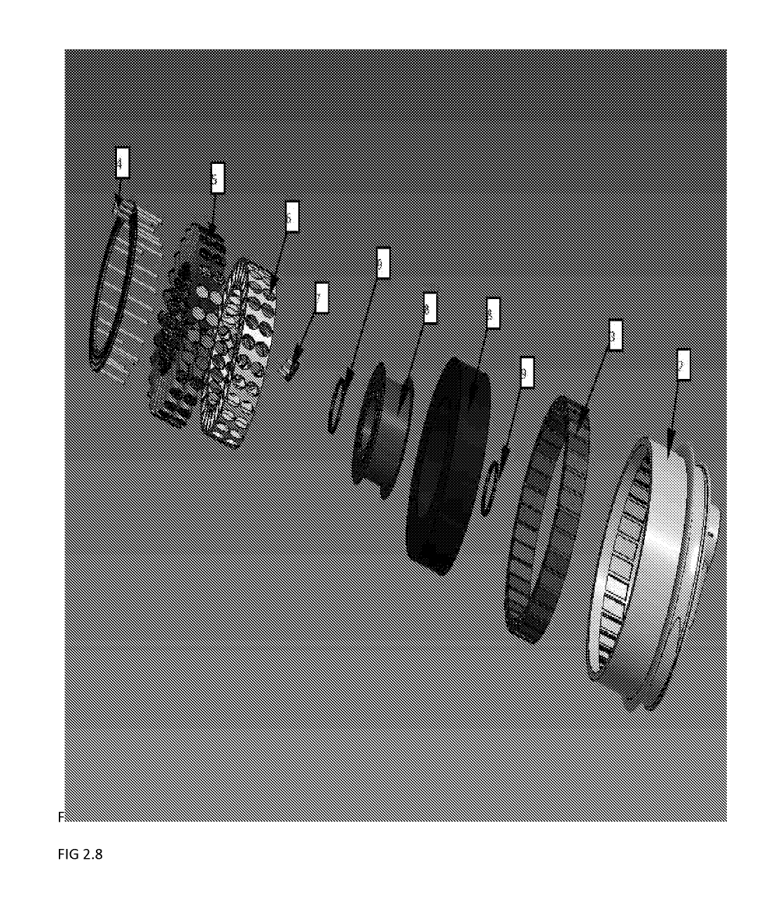

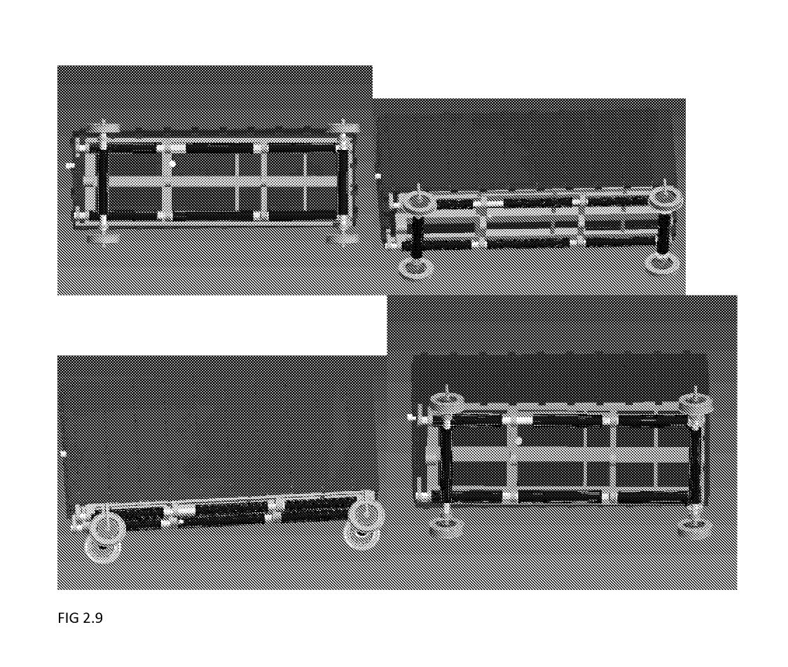

Page 42. FIG. 002 Is of the components of a wheel Axle that is configured into a 3 phase generator system.

This is an open view of components 1. Through 7. Each is defined on page 97

29 Mechanical Electric wheel Axle: a magnet holder wheel Axle with an exterior stator for power generation from the rotation movement of the magnet holder wheel Axle. It is a generator.

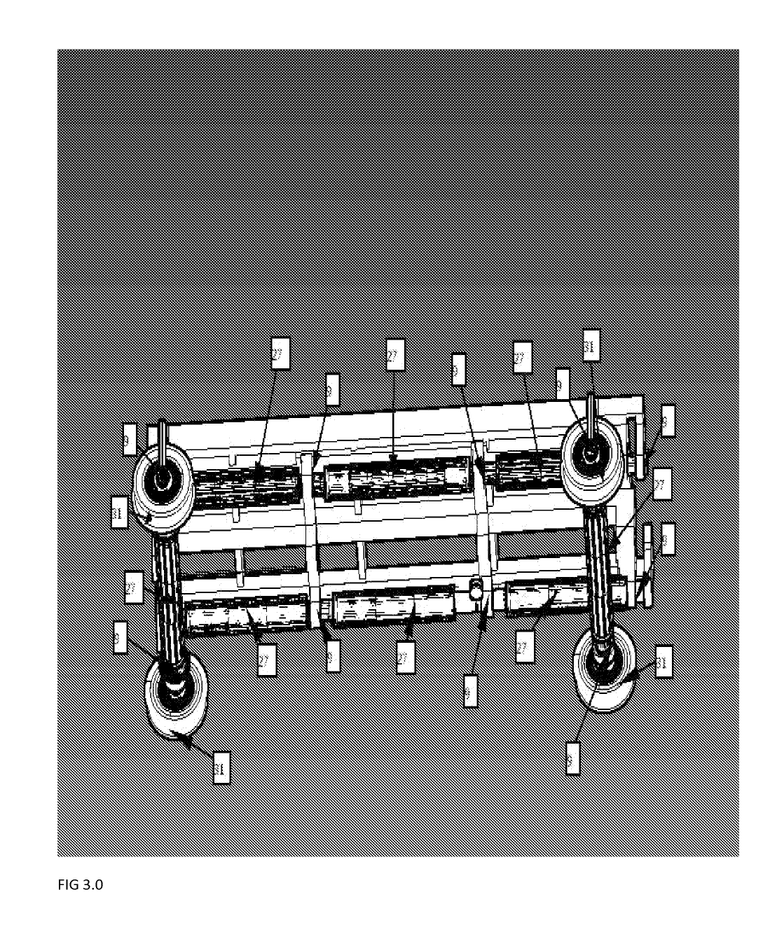

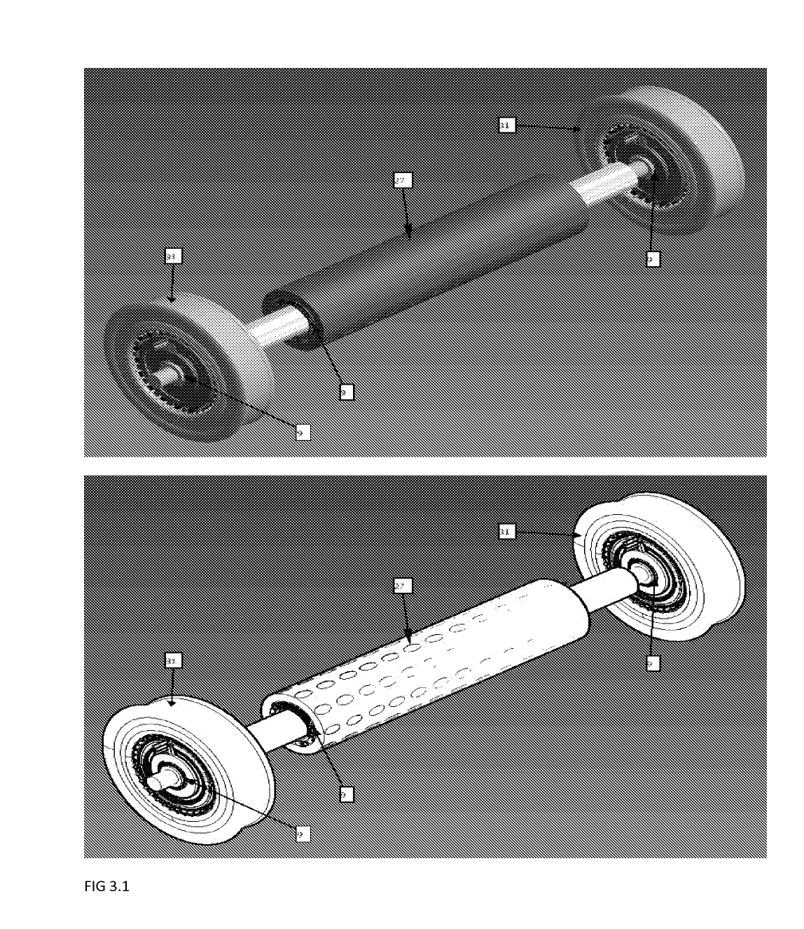

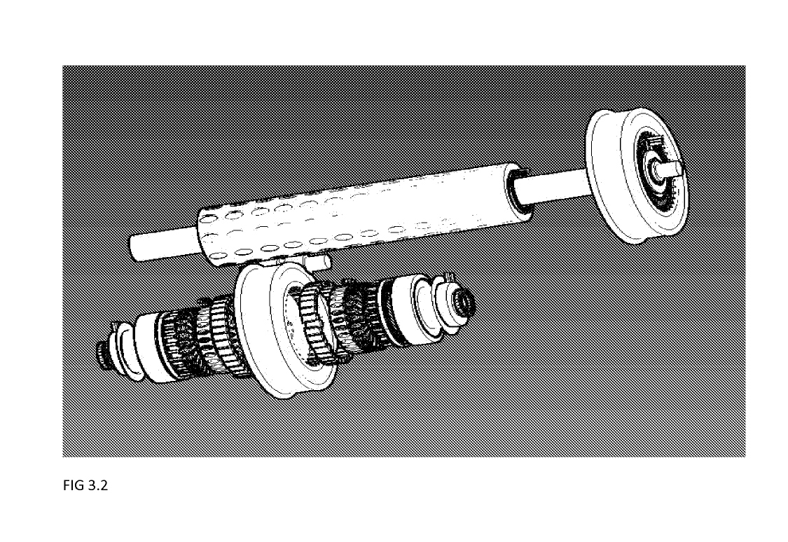

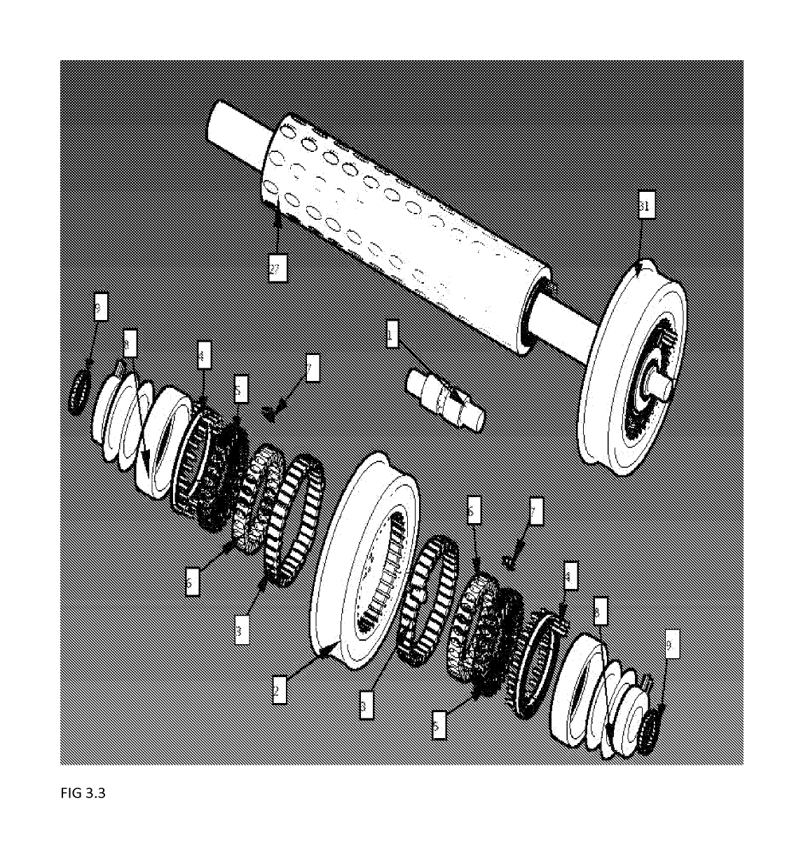

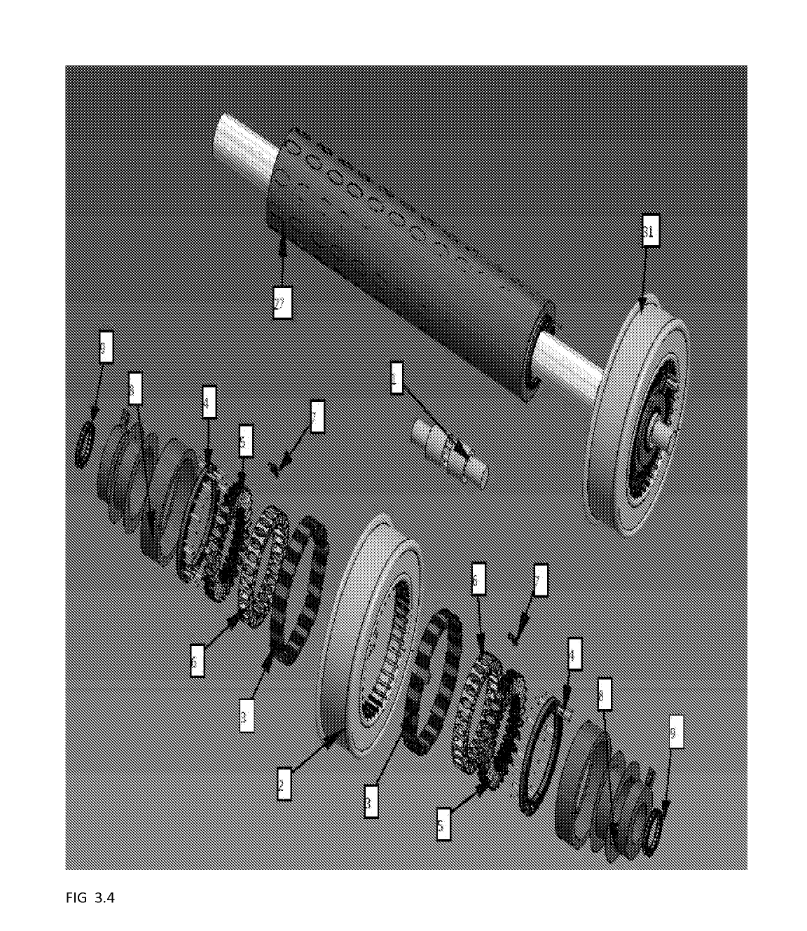

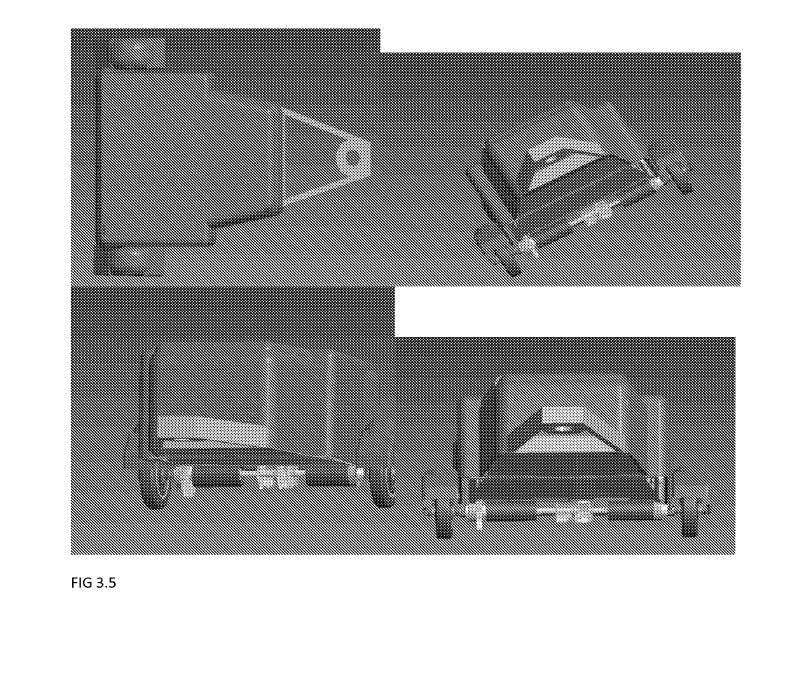

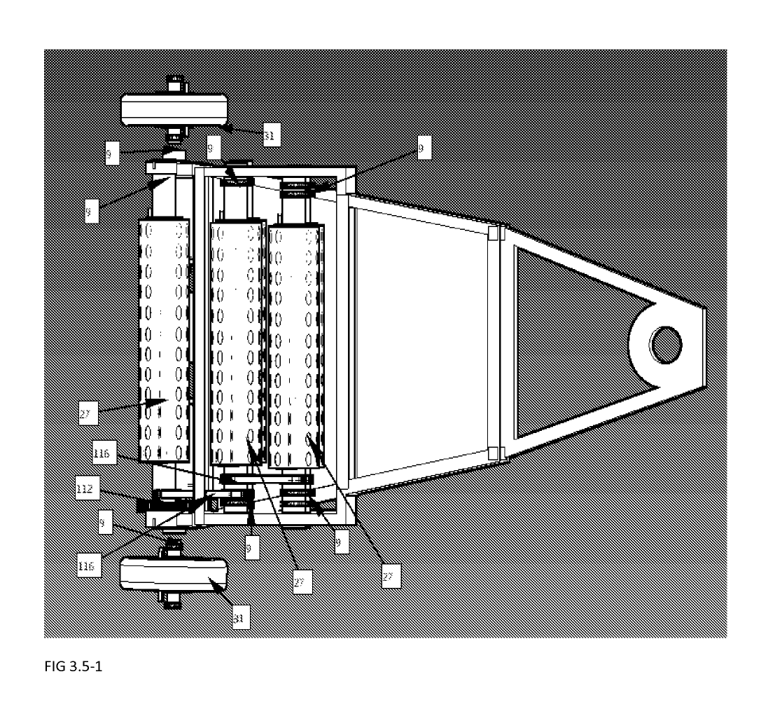

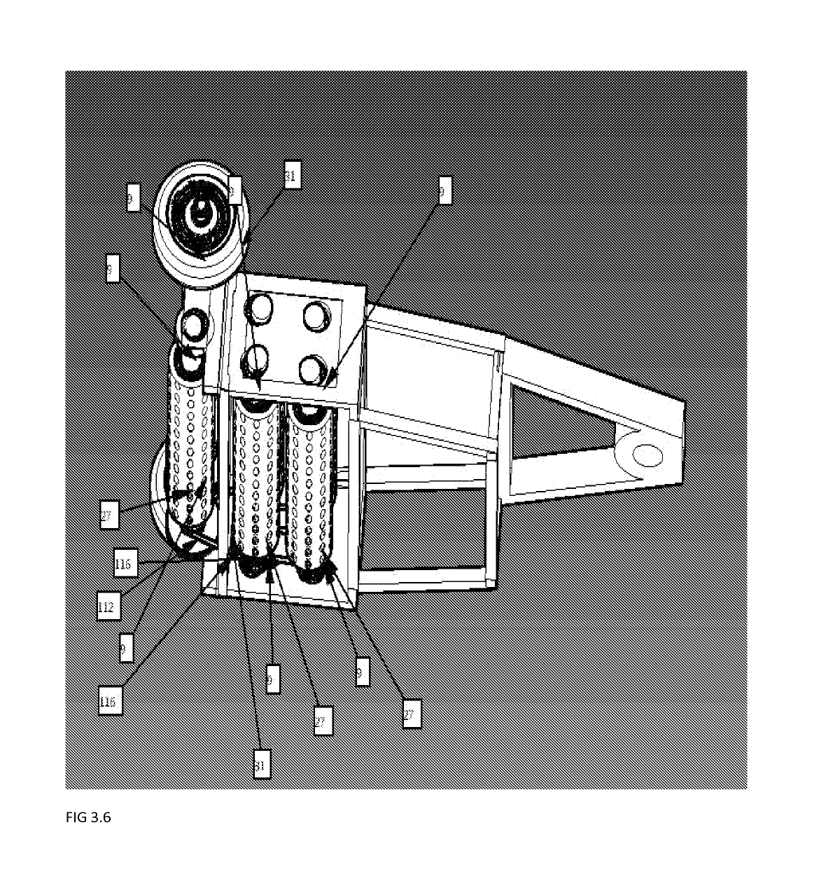

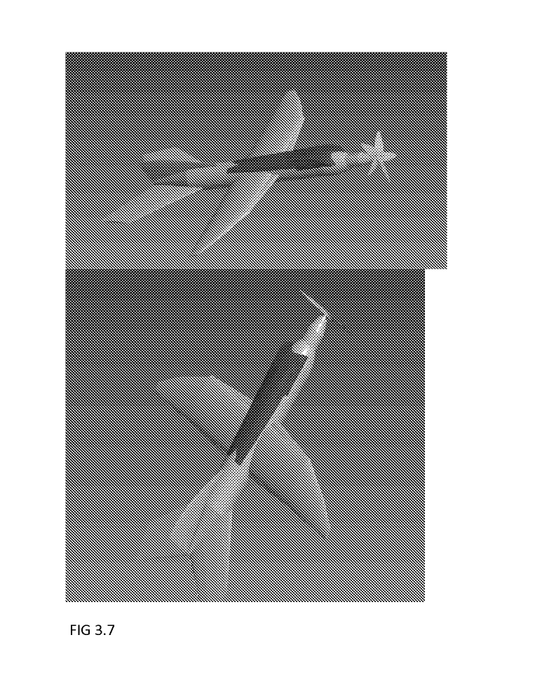

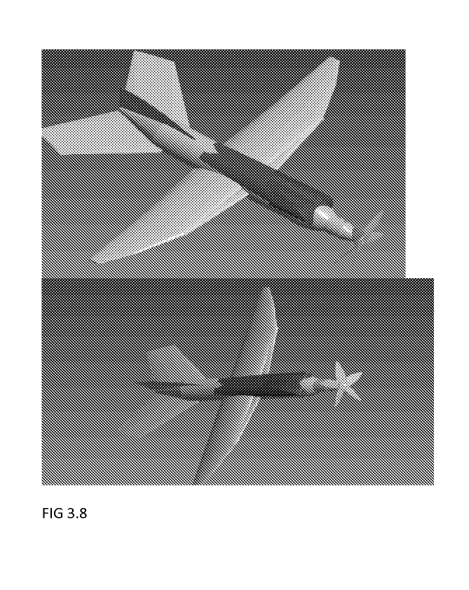

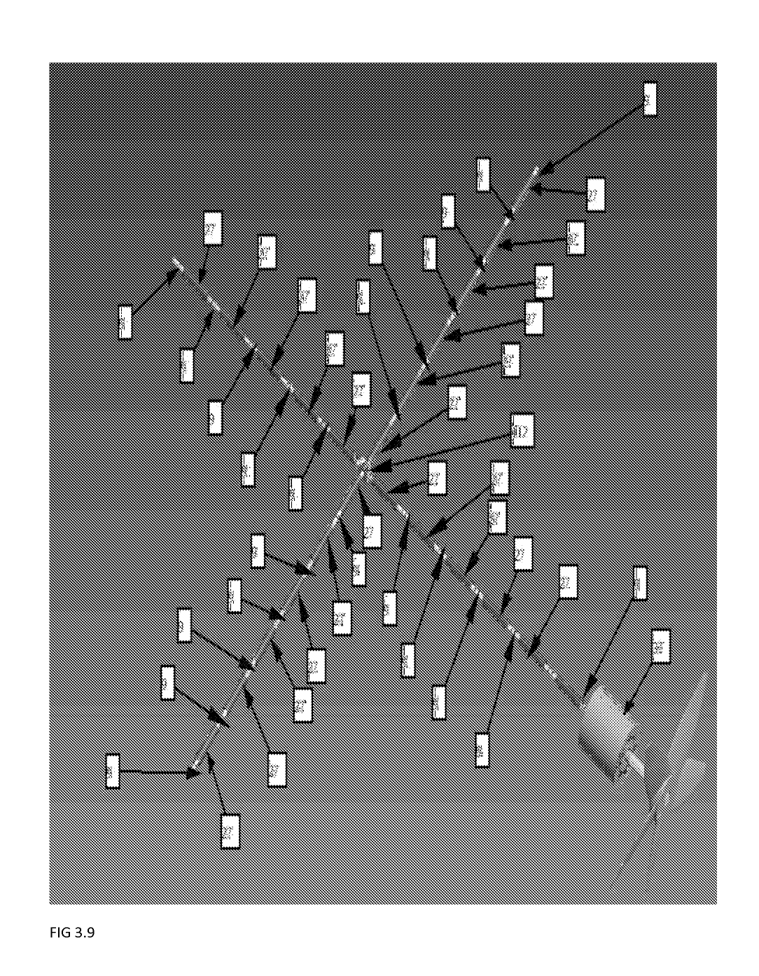

Page 43. FIG. 003 Is of the components of a wheel that is configured into a 3 phase generator system.

This is an open view of components 1. Through 11. Each is defined on page 97

31 mechanical electrical wheels: a magnet holder tire rim with an interior or exterior stator for power generation from the rotation movement of the magnet holder tire rim. It is a generator.

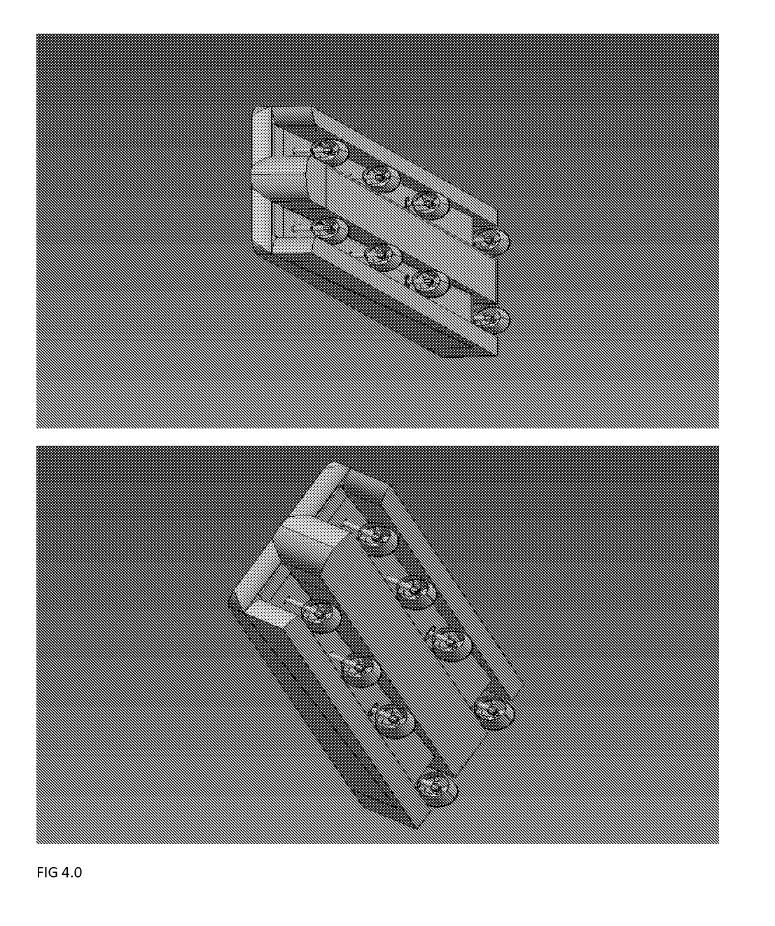

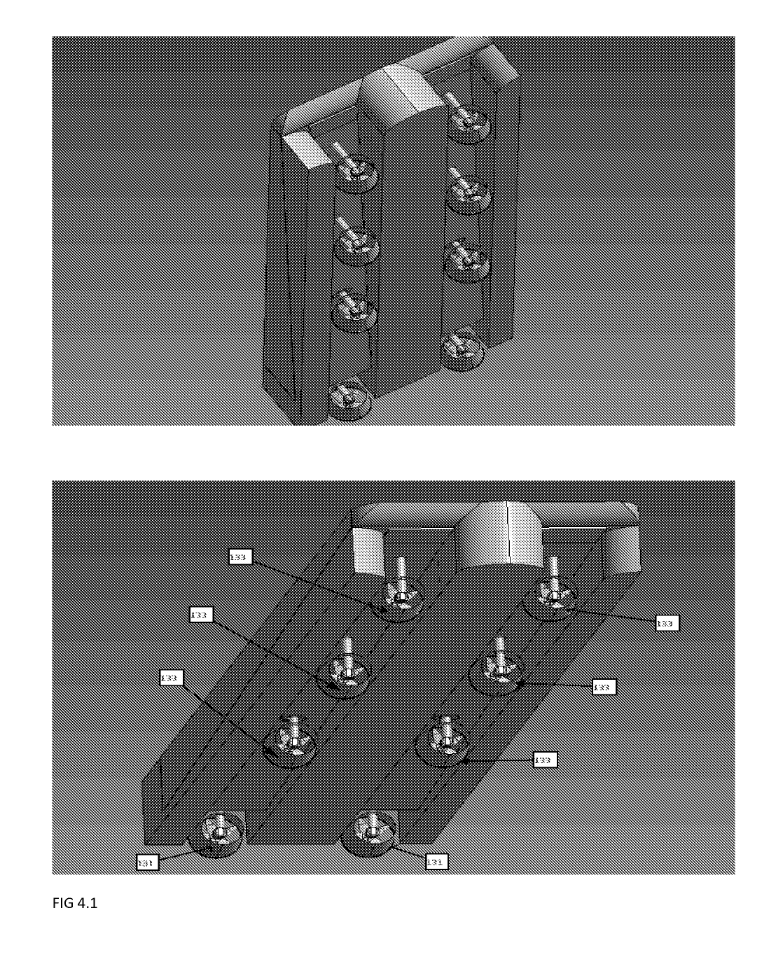

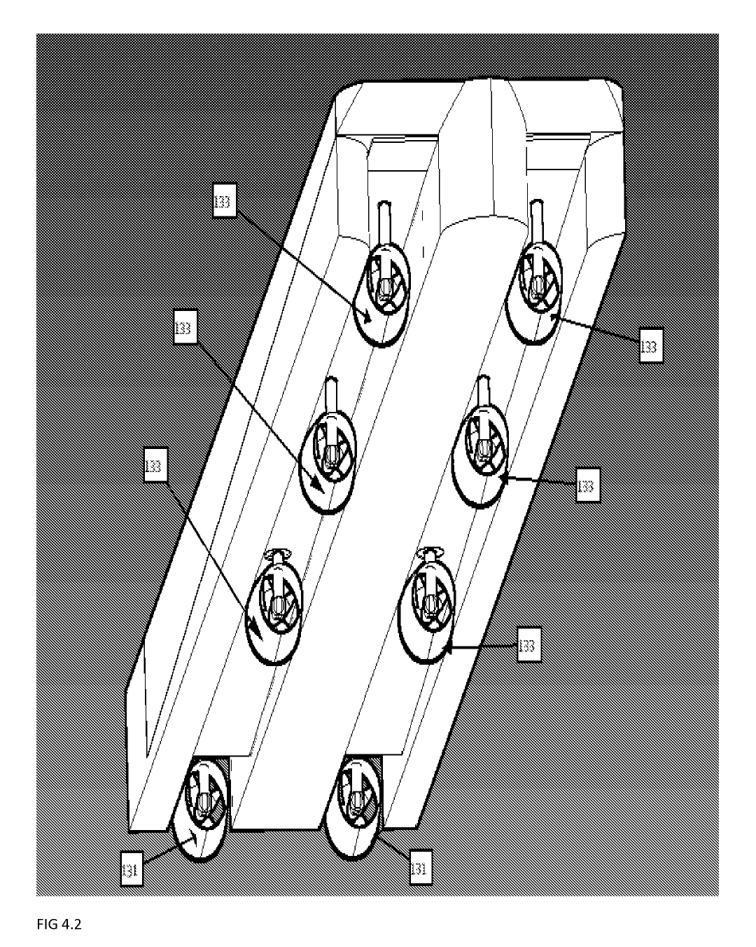

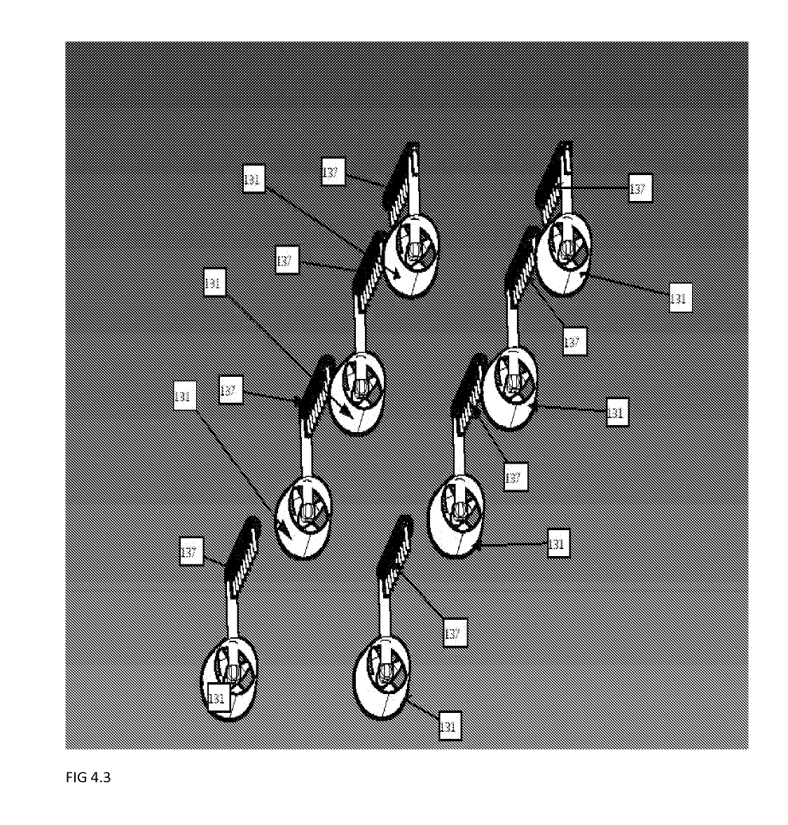

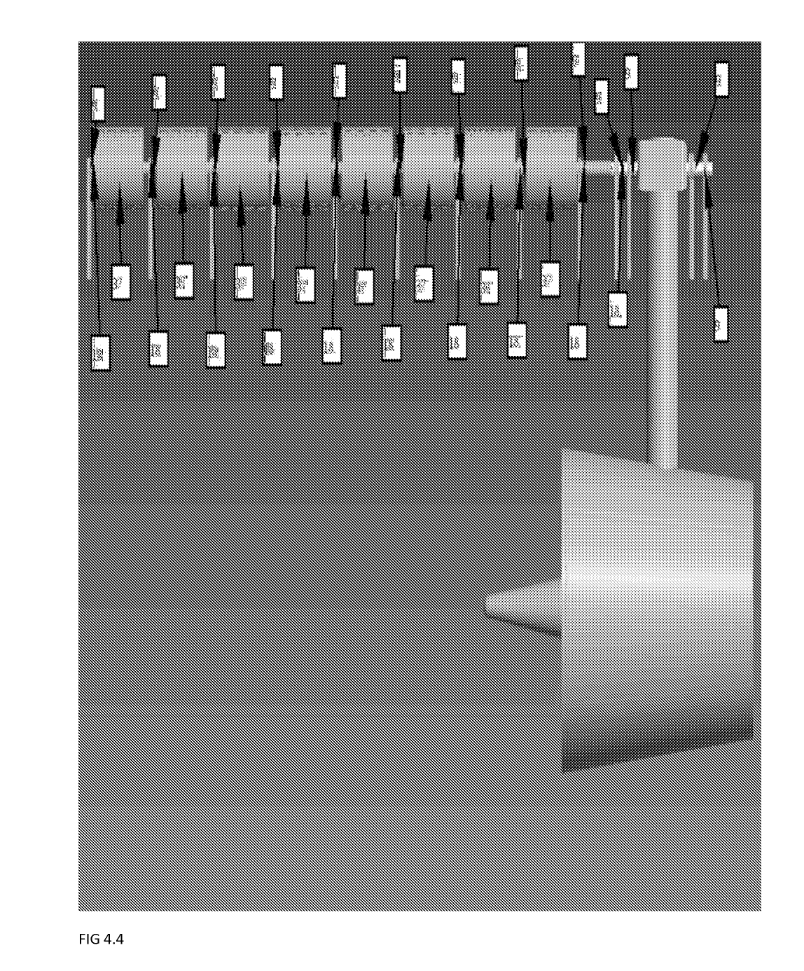

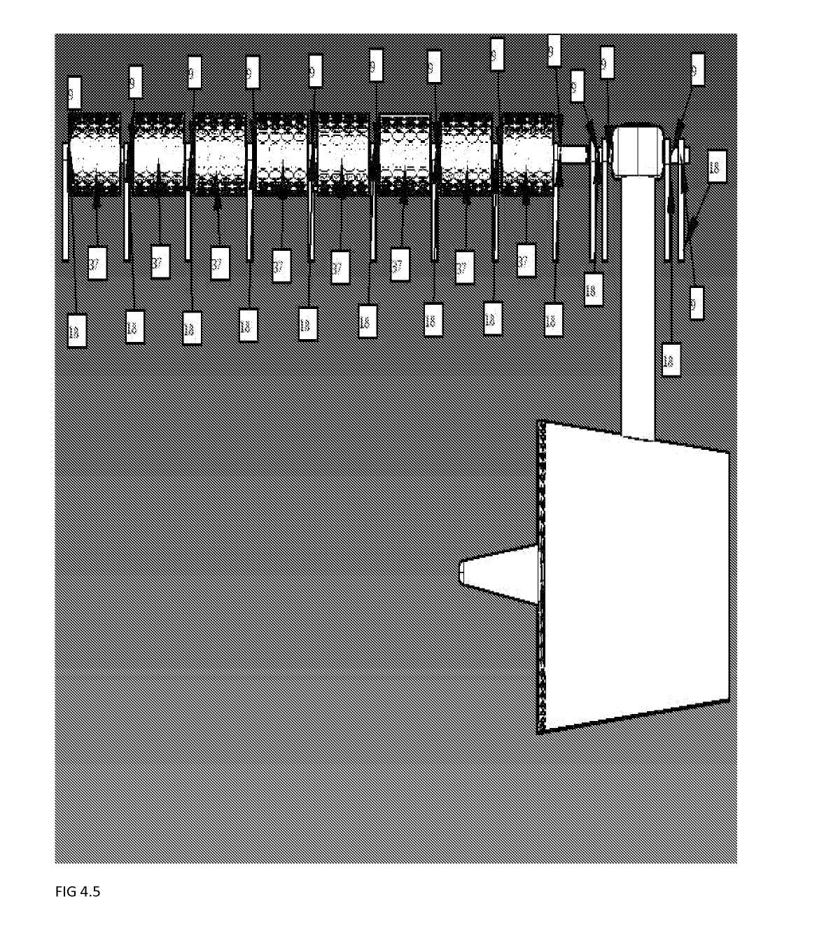

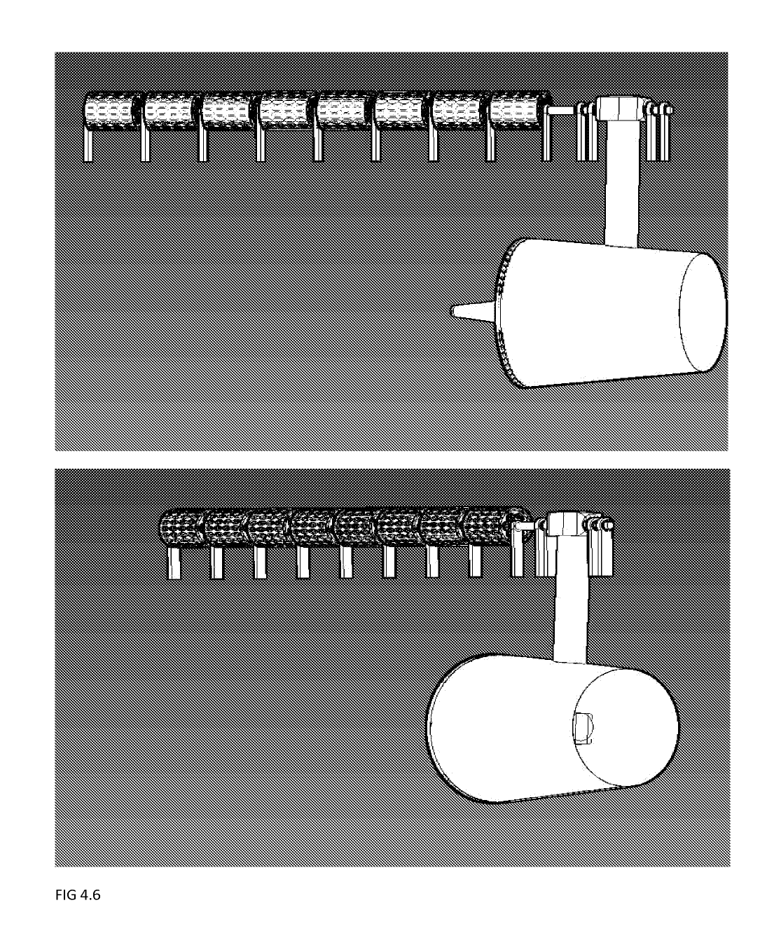

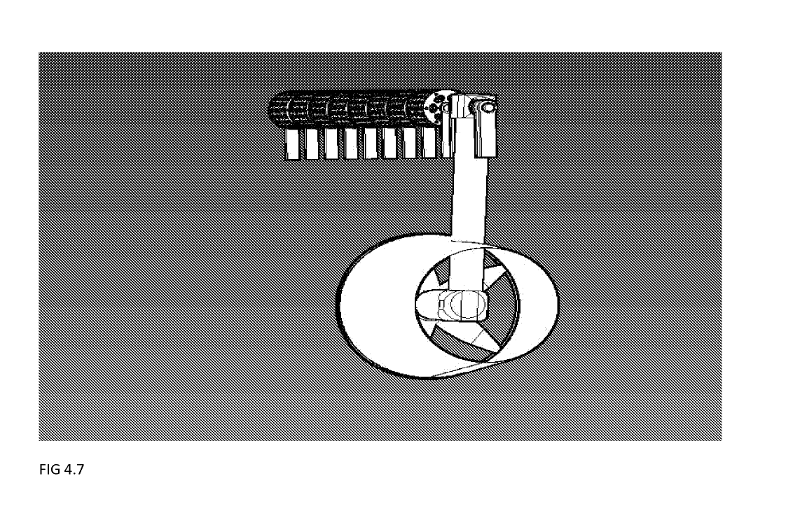

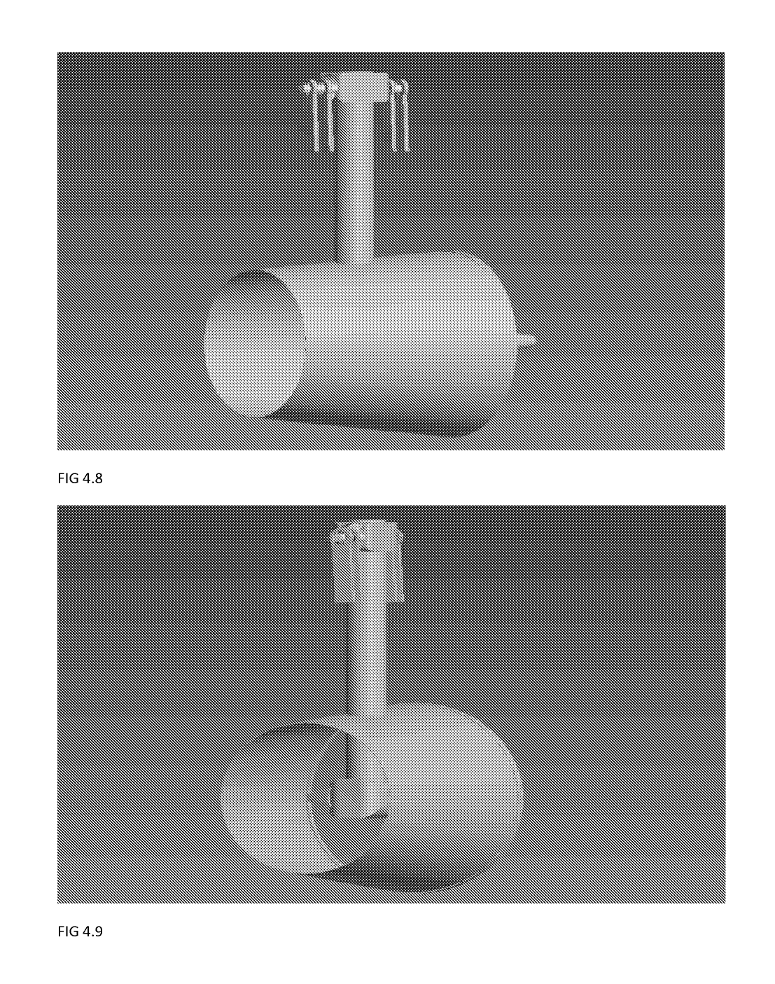

Page 43. FIG. 004 Is of the components of a vehicle attachments that is configure into a 3 phase generator system.

This is an open view of components 1. Through 13. Each is defined on page 97

33 mechanical electric vehicle attachments: a magnet holder tire rim with an interior or exterior attached to the vehicle stator for power generation from the rotation movement of the magnet holder tire rim. It's a generator.

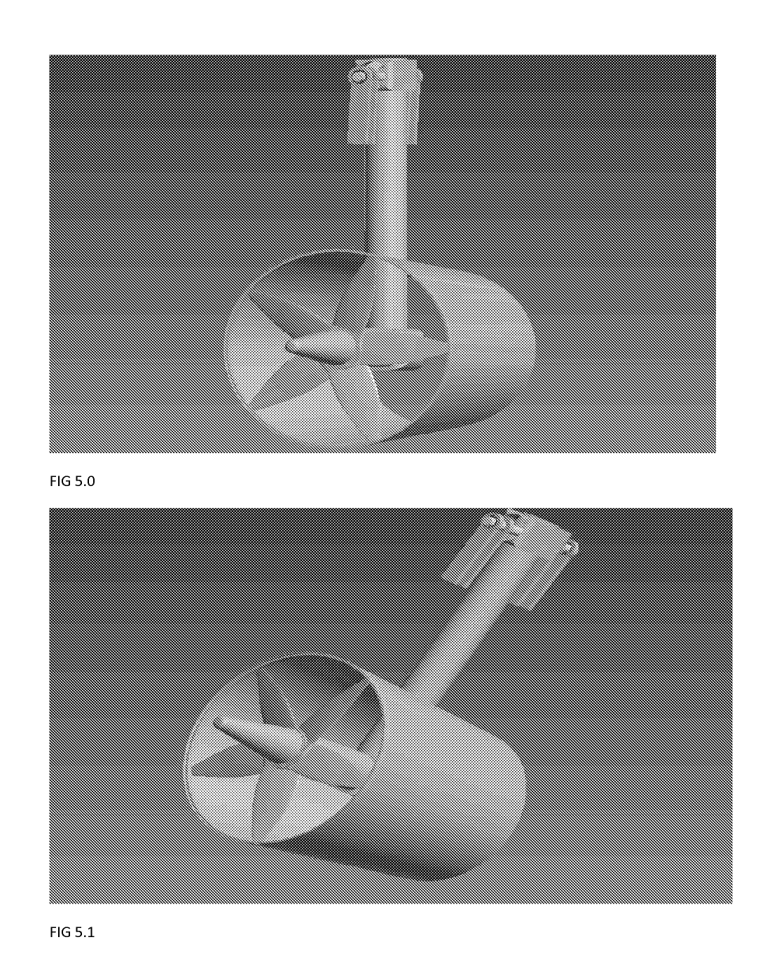

Page 45. FIG. 005 Are of bottom view of the components of a truck trailer powertrain with multi 31 wheels and 27 driveshaft's that is configure into a 3 phase generator system.

This is bottom view of components 31 wheels and 27 driveshaft. Each is defined on page 97

35 mechanical electric vehicle trailers: a trailer can have all from 27, through 33 as enhancements to supply power generation.

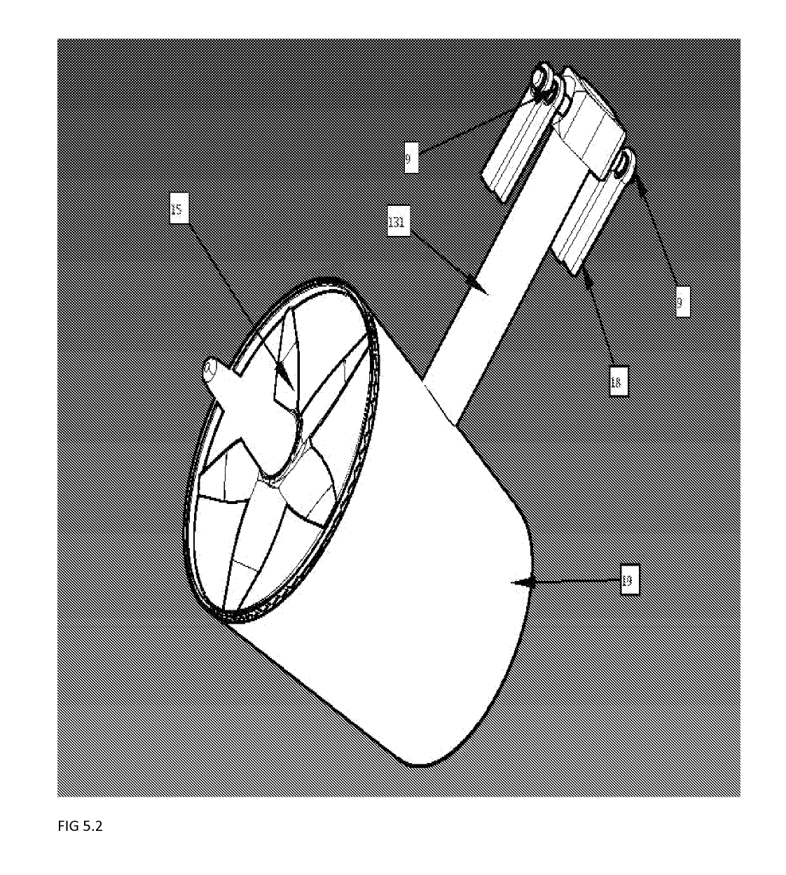

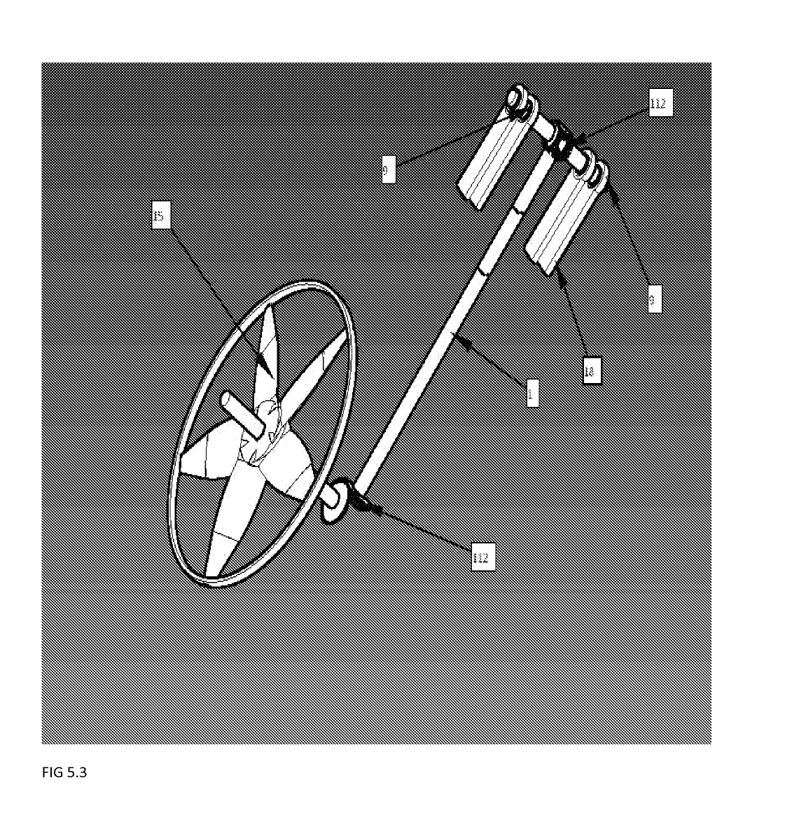

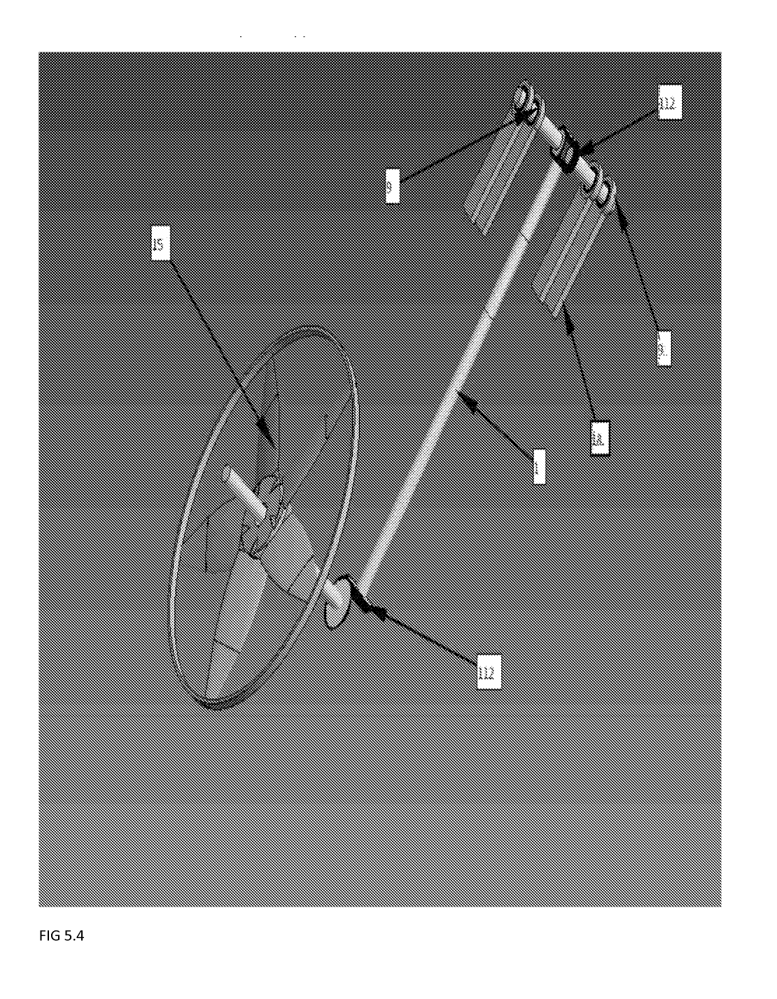

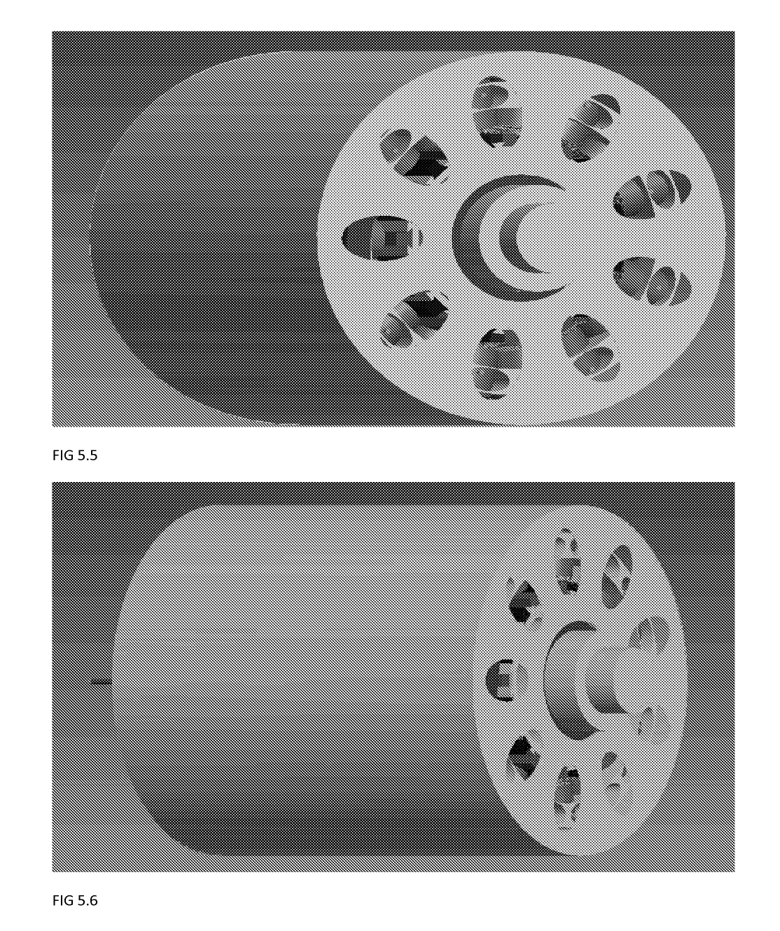

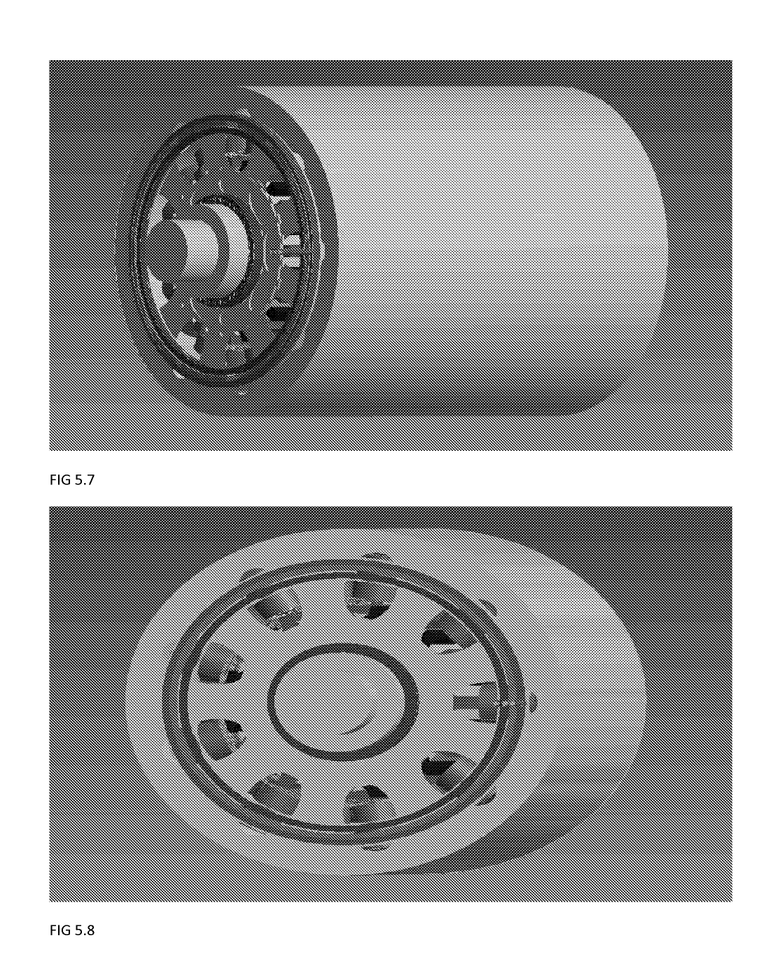

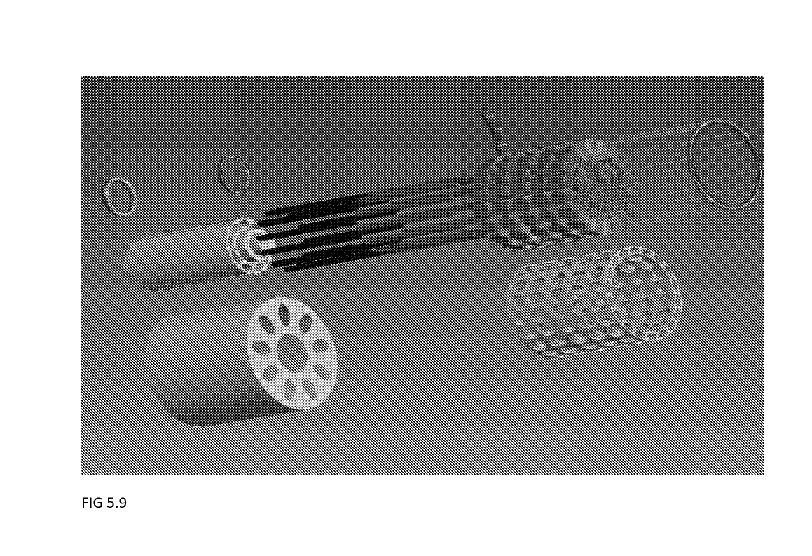

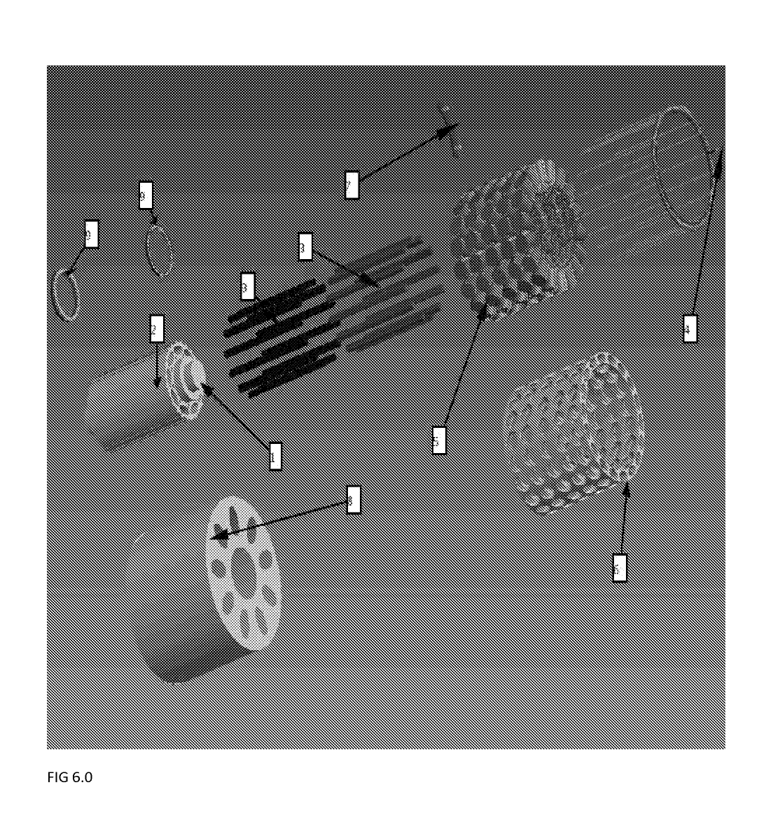

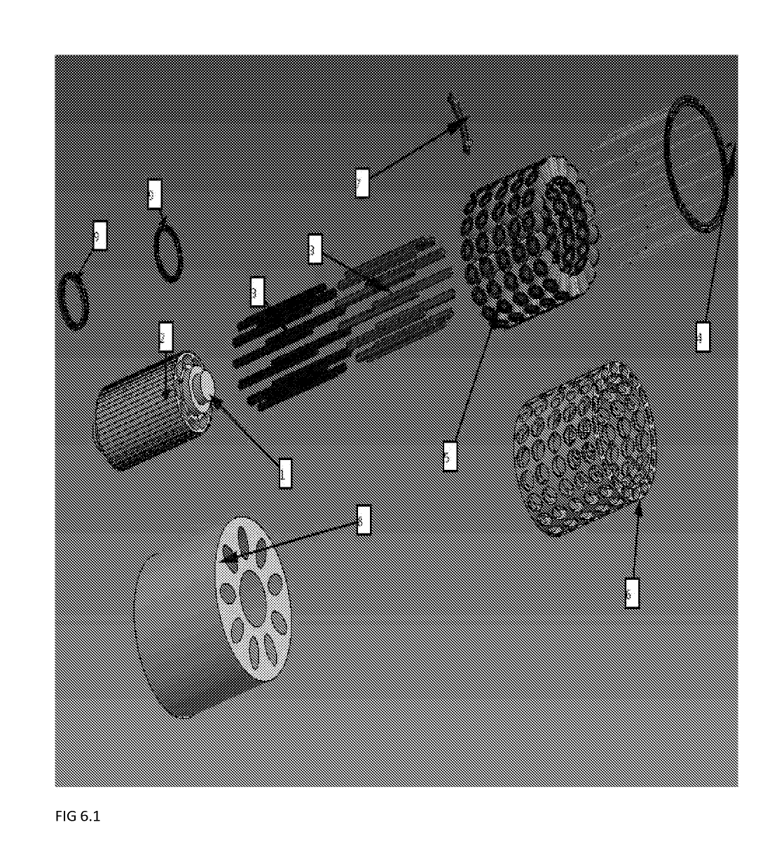

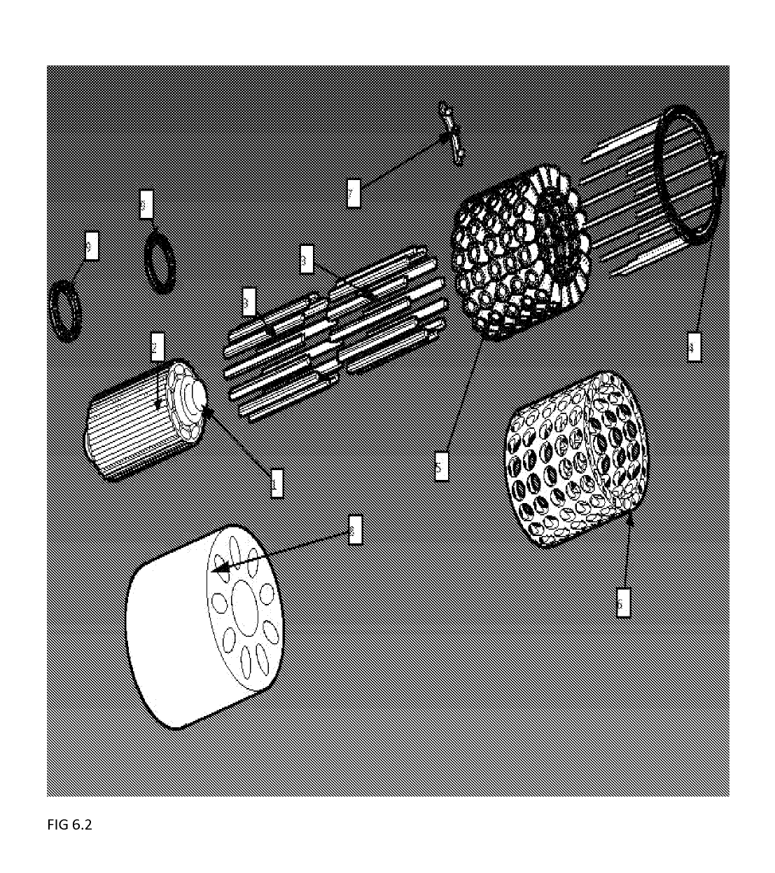

Page 46. FIG. 006 Are of bottom view of the components of a truck trailer powertrain with multi 31 wheels and 27 driveshaft's that is configure into a 3 phase generator system.

This is bottom view of components 31 wheels and 27 driveshaft. Each is defined on page 97

Page 47. FIG. 007 Is of the components of a 3 phase electric motor that can be configure into a 3 phase generator system or transmission.

This is an open view of components 1. Through 8. Each is defined on page 97

Page 48. FIG. 1.1

Figures is a system schematic of an energy system and powertrain views for use in a car page 48 FIG. 1.1 page 49 FIG. 1.2 page 50 FIG. 1.3

Page 51 FIG. 1.4 is a side view of a 27 driveshaft generator system.

Page 52 FIG. 1.5 is the open views of this generator system.

Page 53 FIG. 1.6 is side view of a 31 wheel generator system.

Page 54 FIG. 1.7 is an open view of the components of the 31 wheel generator system.

Page 55 FIG. 1.8 is side view of 31 dual wheel generator system.

Page 56 FIG. 1.9 is the open view of the components of this generator system.

Page 57 FIG. 2.0 is side view of electric bike.

Page 58 FIG. 2.1 is of bike powertrain bottom view.

Page 59 FIG. 2.2 is bottom view of truck powertrain.

Page 60 FIG. 2.3 is bottom view of a truck trailer powertrain.

Page 61 FIG. 2.4 is of bottom views of a locomotive.

Page 62 FIG. 2.5 is of the bottom view of the locomotive powertrain.

Page 63 FIG. 2.6 is of side and front views of a train 31 wheels

Page 64 FIG. 2.7 is of the open view of train 31 wheel components.

Page 65 FIG. 2.8 same train 31 wheel open view of components.

Page 66 FIG. 2.9 and page 67 FIG. 3.0 is of train trailer bottom powertrain.

Pages 68 FIG. 3.1 are of the 31 train wheels and 27 driveshaft side views.

Pages 69 FIG. 3.2, 70 FIGS. 3.3 and 71 FIG. 3.4 is of open views of 31 train wheels and 27 driveshaft.

Page 72 FIG. 3.5 is views of a vehicle trailer. Pages 73 FIGS. 3.6 and 74 FIG. 3.6 are open views of the powertrain system.

Pages 75 FIG. 3.7 and page 76 FIG. 3.8 are side views of an airplane.

Page 77 FIG. 3.9 is the open view of an airplane powertrain system.

Pages 78 FIG. 4.0, 79 FIGS. 4.1 and 80 FIG. 4.2 are side and bottom views of a ship powertrain system.

Pages 81 FIG. 4.3, 82 FIG. 4.4, 83 FIG. 4.5, 84 FIG. 4.6, 85 FIG. 4.7 are of the ships powertrain main movers or open views of the motors and generator series.

Pages 86 FIG. 4.8, FIG. 4.9, 87 FIG. 5.0, FIG. 5.1 and page 88 FIG. 5.2 are different side views of the propeller housing.

Pages 89 FIG. 5.3, 90 FIG. 5.4 are open views of propeller system.

Pages 91 FIG. 5.5, FIGS. 5.6 and 92 FIG. 5.7, FIG. 5.8 are of top and side views of a 37 3 phase motor.

Pages 93 FIG. 5.9, 94 FIG. 6.0, 95 FIG. 6.1, 96 FIG. 6.2 are of open views of a 3 phase motor showing the components of the generator.

### DETAILED DESCRIPTION OF THE INVENTION

broadly, an embodiment of the present invention provides a system and Method of generating electricity from a vehicle having an electrically operable drive And 37 motor. The vehicle could be designed to restore all the electricity it used. By Connecting the 27 mechanical electric drive shaft or shafts and or 29 mechanical electric Wheel Axle or axles, and or the 31 mechanical electrical wheels and or 33 mechanical electric Vehicle attachment or attachments and or a 35 mechanical electric vehicle trailer or trailers, which all “27, 29, 31, 33, 35” create 3 phase DC or AC electricity to power the vehicle's inverter if needed And store it in batteries. An inverter can be used to send that power to the 37 motor When needed. In some embodiments, excess power can be output from the vehicle for utilities. No known machine uses the mechanical energy of a vehicle To generate its own Electricity without the use of fossil fuels as is done with the Present invention.

Referring now to Pages 43 FIGS. 001 through Pages 48 FIG. 007 a car/truck/bike configuration of an energy System may include a 37 electric motor on a vehicle to drive 31 mechanical electric wheels of the vehicle.

The 27 mechanical electric drive shaft of the vehicle can include gears sets. The gears sets or a torque Converter, for example. The gears sets can drive the 27 Mechanical electric drive shaft, the 29 mechanical electric wheels Axles and the 31 Mechanical electric wheels which can, via an AC/DC inverter, Store energy in a battery to be available for the 37 electric Motor.
This power can be used for utilities as needed, for example. The mechanical electric Parts 27 mechanical electric drive shafts, 29 mechanical electric wheel axles and 31 Mechanical electric wheels designed in various sizes, Depending on application. In an Exemplary embodiment, the 27 mechanical electric drive shafts, The 29 mechanical Electric wheel axle and the 31 mechanical electric wheels and or 33 mechanical Electric vehicle attachment and a 35 mechanical electric vehicle trailer may create From 0 to 300 kilowatt (KW) of clean electricity or more from the conversion of Kinetic Energy that the vehicle creates in movement.

Referring to pages 77 FIGS. 3.8 THROUGH page 79 FIG. 4.0, an aircraft configuration of a mechanical electric energy generation system is Shown. This configuration can be very similar to the car/truck/bike configuration, Where system may include a 37 electric motor on a vehicle to drive one or more 27 Mechanical electric drive shafts may, via gears, drive one or more 35 mechanical electric vehicle trailers or 29 mechanical electric wheel Axles or 31 mechanical electric Wheels or 33 mechanical electric attachments, where they may create power for battery storage and or Electric flywheel storage and or output to utilities for example.

Referring to pages 60 FIG. 2.2 THROUGH to 76 FIGS. 3.7, a multiple axle vehicle Configuration of energy System is shown. With multiple axles, multiple 27 Mechanical electric drive shafts interconnect the multiple axles, providing regions For multiple gears to be used to generate Rotational power to drive A plurality of the 27 mechanical electric drive shaft or 29 mechanical electric Wheel Axle or and the 31 mechanical electrical wheels and or 33 mechanical electric Vehicle attachment and or a 35 mechanical electric vehicle trailer generators. Similar To the car/truck/bike Configuration, the multiple axle vehicle configurations can Generate power for driving The 37 electric motor as well as generating power for Electric batteries or flywheel storage and Eventual output for utilities, for example.

Referring now to figures on pages 62 FIGS. 2.4 THROUGH 76 FIGS. 3.7, an alternate Embodiment of the locomotive Configuration of FIG. 1.1 is shown. In this Embodiment, in addition to the design of FIG. 1.1, the embodiment of Figures on Pages 48 THROUGH 61 can include gears sets not only on the 27 Mechanical electric drive shaft, but also on 29 Mechanical electric wheel axles of The locomotive. This configuration may take advantage of multiple rotating shafts (27 Mechanical electric drive shaft, 29 Mechanical electric wheel axles and 31 Mechanical electric wheels) to Provide power or electric generation to the Electric 37 motor and or out to storage or utilities.

Referring to Figures page 80 FIGS. 4.0 through 98 FIG. 6.2 OF a Ship power train and page 46 FIG. 004 33 Vehicle Attachment and Referring to Figures pages 47 FIGS. 005 through 48 FIG. 006 and page 62 FIGS. 2.3 pages 63 FIG. 2.4 and page 68 FIGS. 2.9 through pages 76 FIGS. 3.6 vehicle trailer, alternate Embodiments of a SHIP, 33 vehicle attachment and a 35 vehicle trailer Of configurations are shown. In these embodiments, the electric 37 motor may turn 27 mechanical electric drive shaft, 29 mechanical electric wheel axle, 31 mechanical Electric Wheels and or 33 mechanical electric attachments or a 35 mechanical Electric vehicle trailer to create clean fossil fuel free electricity from the 37 electric Motor. This electric 3 phases DC or AC can be converted for to the 37 electric motor Via an inverter. That Power may be output to flywheel storage and/or output to Utilities.

Referring to Figures page 80 FIGS. 4.0 through 98 FIG. 6.2, a SHIP configuration of an Energy system is shown. The 37 mechanical electric 3 phase motor can act as a Generator/a motor and a transmission as well a shaft driver when connected in Series. In figures on page 83 FIGS. 4.3 through 4.9, is a set of 37 mechanical electric 3 phase motors or generators or transmissions. By adding power to the three phase controls the motor will turn its magnetic shaft as a motor. By changing the power input of the control Wires you change the direction of the motor as a transmission. By using a series of 37 mechanical electric motors connected by shafts as in figures on page 72 there Are 8 in series? Power can be added to all 8 as motors or power can be added to just 4 or any number as needed. All 37 motors that are receiving rotational output from The 4, 37 motor that are powered will start generating mechanical electric as a Generator. This Ship Shows 16, 37 mechanical electric motors to power the ship with A power plant of 48 same size 37 mechanical electric harness generators powered by the 8, 131 propellers and turbines. Plenty of Storage place for batteries. While the above refers to specific vehicles (cars, trucks, Bikes, aircraft, locomotives), other vehicles that may have an electric motor turning A 27 mechanical electric drive shaft, 29 mechanical electric wheel axle, 31 Mechanical electric wheels and or 33 mechanical electric attachments or a 35 Mechanical electric trailer could benefit from the system and methods of the Present Invention.

1. The first OPEN energy system for a vehicle wherein no fossil fuels to be used of any kind Comprising of: An 37 electric motor adapted to drive the vehicle via at least one set of gears receiving rotation output from 37 electric motor which in turn rotates the 27 mechanical electric drive shaft and Or a 29 mechanical electric wheel axle; At least one 31 mechanical electric wheel receiving rotation Output from the at least One gear set.
The energy system of claim 1, where in at least one 33 mechanical electric Attachment and or a 35 mechanical electric vehicle trailer for electric generation.
The energy system of claim 1, wherein at least one 27 Mechanical Electric drive shaft and or the 29 mechanical electric wheel axles or At least one 31 Mechanical electric wheel and or 33 mechanical electric attachments connected to receive Rotation output from the same 37 electric motor.

4. The energy system of claim 1, further comprising an inverter to convert power generated by the At least one 27 mechanical electric drive shaft and Or the 29 mechanical electric wheel axles;

5. The energy system of claim 1, further comprising gears sets Receiving rotation input from a 27 mechanical electric drive shaft, and more Gears sets giving Rotation output to a 29 mechanical electric wheel axles as needed.

6. The energy system of claim 1, wherein the vehicle is a multiple 29 mechanical Electric wheel axle Vehicle such as a truck or locomotive. This makes for multiple places To generate clean electricity by using every dive shaft, wheel axle and wheels as generators collecting Kinetic energy and converting it to clean electricity.

7. The energy system of claim 7, wherein multiple Axle sets are places where Kinetic Energy can be Harnessed and converted to electricity with the use of the 27 mechanical electric drive shaft and the Multiple 29 mechanical electric wheel axles and the multiple 31 mechanical electric wheels and the 33 Mechanical electrical vehicle attachments and the 35 mechanical electric trailers.

8. The energy system of claim 8, wherein all the mechanical electrical generators (27, 29, 31, 33, 35) can Be converted to the size needed for use in or on any vehicle as needed for power production. The excess Power can be stored in batteries and or output to flywheel storage and or output to utilities. No known Art has proven to do this and can power it's self fully today without the use of the above systems.

9. The first Open thermodynamic energy system for vehicles comprising:
An 37 electric motor adapted to drive the vehicle via at least one of a 27 Mechanical electric drive shaft. Which will output rotational forces to turn a 29 mechanical electric wheel axle and or 31 Mechanical electric Wheels to generate power to Supply at least one energy storage device receiving power output from the 27 mechanical electric drive shaft and or the 29 mechanical electric Wheel axles and or 33 vehicle attachment and or a 35 mechanical electric vehicle Trailer or and have an inverter to convert power generated to power usable to power the 37 electric motor, wherein: The at least one energy storage device includes one or more Batteries, the at least one energy storage device includes an output system for flywheel Storage and or output to utilities.

10. The energy system of claim 10, wherein the vehicle use no fossil fuels and is a Multiple axles Vehicle.

11. The energy system of claim 1, wherein multiple uses can be adapted to any vehicle and or to Machines and or war machines and or space flight and or Laser Guns etc.

12. The energy system of claim 1, wherein the vehicle is any vehicle with wheels, Drive shafts and wheel axles and or attachments and or trailers and or propellers in air or water That is upgraded to power generator systems as these inventions.

13. The energy system of claim 1, Wherein the vehicle could include multiple 37 mechanical electric 3 phase motors can act as Generators or a motor and or a transmission as well a shaft driver when connected in Series. A set of 37 mechanical electric 3 phase motors or generators or transmissions. By adding power to the three phase controls the motor will turn its magnetic shaft as a motor. By changing the power input of the control Wires you change the direction of the motor as a transmission. By using a series of [8] 37 mechanical electric motors connected by shafts. Power can be added to all 8 as motors or power can Be added to just [4] or any number as needed. All 37 motors that are receiving rotational output from The [4] 37 motor that are powered will start generating mechanical electric as a Generator because of rotation of the magnetic field.

14. The energy system of claim 14, wherein a ship or airplane with multiple 37 mechanical electric Motors to power the ship connected in series with multiple same size 37 mechanical electric harness Generators that can be used as the power plant for the ship or air plane designs. It will need plenty of Storage place for batteries and or output to flywheel storage and or utilities. While the above refers to Specific vehicles (cars, trucks, boats, bikes, aircraft, locomotives), other vehicles that may have an Electric motor turning a 27 mechanical electric drive shaft, 29 mechanical electric wheel axle, 31 Mechanical electric wheels and or 33 mechanical electric attachments or a 35 mechanical electric trailer Could benefit from the system and methods of the present Invention.

15. The energy system of claim 1, wherein the first Open thermodynamic system for a vehicle to be Introduced as the example of every Open thermodynamic system to follow.
The definition of an open thermodynamic system assumes that there are supplies of energy that Cannot be depleted; in practice, this energy is supplied from some source in the surrounding Environment, which can be treated as infinite.
The Closed thermodynamic systems for vehicles use the drive shafts and wheel axles and the wheels to Deplete the fossil fuel supply. In contrast the Open thermodynamic system for vehicles use the 27 Mechanical electric harness drive shaft system which generates electricity as well as the 29 mechanical Electrical harness wheel axles as well as the 31 mechanical electric harness wheels as well as the 33 Mechanical electric harness vehicle attachment as well as the mechanical electric harness vehicle trailers To fully supply any and all energy need without the use of fossil fuels. And supply batteries with storage Power and or output for flywheel storage and or output to utilities or grids.

16. The energy system of claim 15 will power itself without the use of fossil fuels and will store extra energy in batteries and or output to flywheel storage and or utilities or grids

17. The energy system of claim 16 can be used in every device that uses electric power.

18. The energy system of claim 16 is the first working Open thermodynamic system for vehicles that will Advance vehicle transportation by using up to 90% of all kinetic energy created by a vehicle to convert to clean electricity using the drive shaft, wheel axles and wheels as generators harnessing kinetic energy.

19. The energy system of claim 1, wherein the first Open thermodynamic system for a vehicle to be introduced as the example of every Open thermodynamic system to follow.
The definition of an open thermodynamic system assumes that there are supplies of energy that Cannot be depleted; in practice, this energy is supplied from some source in the surrounding environment, which can be treated as infinite.
The Closed thermodynamic systems for vehicles use the drive shafts and wheel axles and the wheels to Deplete the fossil fuel supply. In contrast the Open thermodynamic system for vehicles use the 27 Mechanical electric harness drive shaft system which generates electricity as well as the 29 mechanical Electrical harness wheel axles as well as the 31 mechanical electric harness wheels To fully supply any and all energy need without the use of fossil fuels and or supply batteries with storage Power and or output for flywheel storage and or output to utilities or grids.
